(19) United States
(12) Patent Application Publication
(10) Pub. No.: US 2026/0158991 A1
(43) Pub. Date: Jun. 11, 2026

(54) ELECTRONIC APPARATUS FOR CONTROLLING VEHICLE AND OPERATING METHOD THEREOF

(71) Applicant: 42dot Inc., Seoul (KR)

(72) Inventors: Jonghyuck Heo, Seongnam-si (KR); Hanbyeol Lee, Seongnam-si (KR); Jungmi Park, Seongnam-si (KR)

(73) Assignee: 42dot Inc., Seoul (KR)

(21) Appl. No.: 19/260,131

(22) Filed: Jul. 3, 2025

(30) Foreign Application Priority Data
Jul. 4, 2024 (KR) 10-2024-0088163
Jul. 25, 2024 (KR) 10-2024-0098740
Jul. 29, 2024 (KR) 10-2024-0100395

(51) Int. Cl. B60Q 1/34

(52) U.S. Cl. CPC B60Q 1/346

(57) ABSTRACT

An electronic device for controlling a turn signal and an operating method thereof are provided. A method of controlling a turn signal includes, based on route information of a vehicle, identifying a position where a direction change of the vehicle is required, and based on a distance between the position where the direction change is required and a position of the vehicle, controlling a turn signal of the vehicle corresponding to the direction change.

### TECHNICAL FIELD

The following description relates to an electronic device for controlling a vehicle and an operating method thereof.

### BACKGROUND OF THE INVENTION

A turn signal may be a signal device that a driver uses to notify other drivers of their intention when a vehicle changes a direction. For example, a driver of a vehicle may forewarn other drivers of the movement, such as a left turn, right turn, or lane change, via the turn signal. When multiple vehicles are parked in a limited parking space, the vehicles may be occasionally parked significantly close to each other. This may cause a scratch or damage due to contact between vehicles when the driver opens the door because a gap between the vehicle driven by the driver and a vehicle that is already parked next to the driver's vehicle is narrow.

The scratch or damage of the vehicle may result in the burden of repair costs to the driver, and even cause a conflict between drivers. To resolve this problem, methods of warning a collision with external obstacles when the door of the vehicle of the driver is opened have been proposed.

A user may open or close windows of the vehicle or use an air circulation mode inside the vehicle to control air ventilation in the vehicle. A window system of the vehicle includes components, such as a window motor, a window regulator, a window switch, a control module, electrical wiring, a window glass, and a window seal. The user may open or close the window glass before or while driving as a signal for manipulating or controlling the window switch by the user is transmitted to the window motor. An air circulation system is a function to adjust the air quality in the vehicle and efficiently manage the air quality in the vehicle according to an external environment and is divided into an internal circulation mode to block air from the outside of the vehicle and an external circulation mode for drawing air from the outside of the vehicle. The air inside the vehicle may be ventilated by the user's control to directly open or close the window of the vehicle or directly switch the air circulation mode to the internal circulation mode or the external circulation mode.

The above description has been possessed or acquired by the inventor(s) in the course of conceiving the present disclosure and is not necessarily an art publicly known before the present application is filed.

### DISCLOSURE OF THE INVENTION

### Technical Goals

A method of automatically activating a turn signal of a vehicle and a method for a driver to change a direction of the vehicle via the activated turn signal are demanded to assist driving.

An embodiment may provide a method of controlling a turn signal of a vehicle, according to route information of the vehicle.

An embodiment may provide a method and device for providing a notification from a parked vehicle to the outside.

An embodiment may provide a method and device for controlling ventilation in a vehicle.

However, the technical aspects are not limited to the aforementioned aspects, and other technical aspects may be present.

### Technical Solutions

According to an embodiment, a method of controlling a turn signal includes, based on route information of a vehicle, identifying a position where a direction change of the vehicle is required, and based on a distance between the position where the direction change is required and a position of the vehicle, controlling a turn signal of the vehicle corresponding to the direction change.

The route information is obtained by a navigation system.

The controlling of the turn signal of the vehicle includes calculating a reference distance required for the direction change, and activating the turn signal when the distance between the position where the direction change is required and the position of the vehicle is less than or equal to the reference distance.

The calculating of the reference distance includes differently calculating the reference distance according to a level of a driver of the vehicle.

The level of the driver of the vehicle is determined based on an expected time taken for the driver of the vehicle to perform the direction change.

The calculating of the reference distance includes calculating the reference distance based on a speed limit of a road on which the vehicle is driven.

The method further includes, based on the route information, determining whether the direction change of the vehicle is continuously required. The calculating of the reference distance includes, when the direction change is continuously required, based on a number of continuous direction changes, calculating the reference distance.

The calculating of the reference distance includes calculating the reference distance based on a level of congestion of a road on which the vehicle is to perform the direction change.

The method further includes, when the vehicle does not perform the direction change according to the turn signal, based on changed route information, reidentifying a position where a direction change of the vehicle is required, and based on a distance between the reidentified position where the direction change is required and the position of the vehicle, controlling a turn signal corresponding to the reidentified direction change.

According to an embodiment, an electronic device for controlling a turn signal includes a processor and memory storing instructions, wherein the instructions, when executed by the processor, cause the electronic device to, based on route information of a vehicle, identify a position where a direction change of the vehicle is required. The instructions, when executed by the processor, cause the electronic device to, based on a distance between the position where the direction change is required and a position of the vehicle, control a turn signal of the vehicle corresponding to the direction change.

The route information is obtained by a navigation system.

The instructions, when executed by the processor, cause the electronic device to calculate a reference distance required for the direction change. The instructions, when executed by the processor, cause the electronic device to activate the turn signal when the distance between the position where the direction change is required and the position of the vehicle is less than or equal to the reference distance.

The instructions, when executed by the processor, cause the electronic device to differently calculate the reference distance according to a level of a driver of the vehicle.

The level of the driver of the vehicle is determined based on an expected time taken for the driver of the vehicle to perform the direction change.

The instructions, when executed by the processor, cause the electronic device to calculate the reference distance based on a speed limit of a road on which the vehicle is driven.

The instructions, when executed by the processor, cause the electronic device to, based on the route information, determine whether the direction change of the vehicle is continuously required. The instructions, when executed by the processor, cause the electronic device to, when the direction change is continuously required, based on a number of continuous direction changes, calculate the reference distance.

The instructions, when executed by the processor, cause the electronic device to calculate the reference distance based on a level of congestion of a road on which the vehicle is to perform the direction change.

The instructions, when executed by the processor, cause the electronic device to, when the vehicle does not perform the direction change according to the turn signal, based on changed route information, reidentify a position where a direction change of the vehicle is required. The instructions, when executed by the processor, cause the electronic device to, based on a distance between the reidentified position where the direction change is required and the position of the vehicle, control a turn signal corresponding to the reidentified direction change.

### BRIEF DESCRIPTION OF DRAWINGS

FIG. 1 is an example of a turn signal control system according to an embodiment.

FIG. 2 is a diagram illustrating route information of a vehicle in a turn signal control system, according to an embodiment.

FIGS. 3A to 3F are diagrams illustrating operations of controlling a turn signal in a turn signal control system in various scenarios.

FIG. 4 is an example of a flowchart of a method of controlling a turn signal in a turn signal control system according to an embodiment.

FIG. 5 is an example of an electronic device in a turn signal control system according to an embodiment.

FIGS. 6 to 8 are diagrams illustrating an autonomous driving scheme in a notification providing system according to an embodiment.

FIGS. 9A and 9B are diagrams related to a camera that captures the outside of a vehicle in a notification providing system according to an embodiment.

FIG. 10 is a schematic diagram illustrating an object detection method in a notification providing system according to an embodiment.

FIG. 11A is a diagram of a case in which a vehicle is parked next to a parked vehicle in a notification providing system according to an embodiment.

FIG. 11B is a diagram of a case in which a door is opened in another parked vehicle next to a parked vehicle in a notification providing system according to an embodiment.

FIG. 12 is a flowchart of a method of providing a notification to the outside by an external notification device of a parked vehicle in a notification providing system according to an embodiment.

FIG. 13 is a flowchart of a first condition that needs to be met for an external notification device of a parked vehicle to provide a notification to the outside in a notification providing system according to an embodiment.

FIG. 14 is a flowchart of a second condition that needs to be met for an external notification device of a parked vehicle to provide a notification to the outside in a notification providing system according to an embodiment.

FIG. 15 is a block diagram of an external notification device of a parked vehicle in a notification providing system according to an embodiment.

FIG. 16 is a diagram of a case in which ventilation of a vehicle is automatically controlled in a vehicle ventilation system according to an embodiment.

FIG. 17 is a flowchart of operations of a method of controlling ventilation of a vehicle based on an occurrence of an event in a vehicle ventilation system according to an embodiment.

FIG. 18 is a flowchart of operations of a method of controlling ventilation of a vehicle based on log data of a user in a vehicle ventilation system according to an embodiment.

FIG. 19 is a flowchart of operations of a method of controlling ventilation of a vehicle based on environmental information in a vehicle ventilation system according to an embodiment.

FIG. 20 is a flowchart of operations of a method of controlling ventilation of a vehicle based on a driving speed of the vehicle in a vehicle ventilation system according to an embodiment.

FIG. 21 is a block diagram of components of a control device for controlling ventilation of a vehicle in a vehicle ventilation system according to an embodiment.

### BEST MODE FOR CARRYING OUT THE INVENTION

The following detailed structural or functional description is provided as an example only and various alterations and modifications may be made to the embodiments.

Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly, the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular form is intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

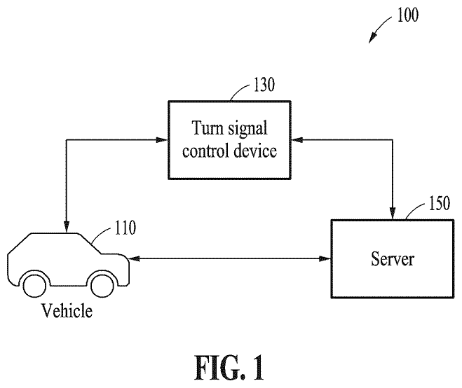

FIG. 1 is an example of a turn signal control system according to an embodiment.

Referring to FIG. 1, a turn signal control system 100 may include a vehicle 110, a turn signal control device 130, and a server 150.

The vehicle 110 may refer to a means of transportation for transporting people. The vehicle 110 may include a signal device (e.g., a turn signal (not shown)). For example, the vehicle 110 may include a means of transportation, such as an automobile, a train, a ship, a boat, and/or an electric bicycle. However, the example is not limited thereto, and the vehicle 110 may include any means of transportation including the turn signal.

The turn signal control device 130 may include a communication module (not shown) for communication between the vehicle 110 and the server 150 or may communicate with the server 150 via an external device (not shown). The turn signal control device 130 may be installed in the vehicle 110 or outside the vehicle 110.

Some and/or all operations performed by the turn signal control device 130 may be performed by the turn signal control device 130 and/or the server 150. Hereinafter, the description is provided based on a premise that the operations are performed by the turn signal control device 130.

The turn signal control device 130 may obtain route information of the vehicle 110. The route information of the vehicle 110 may be obtained by a navigation system. For example, the turn signal control device 130 may receive a user input (e.g., destination information) using various input devices (e.g., a microphone, a physical keyboard, a virtual keyboard, a camera, and/or a detection sensor) and may transmit the destination information to a server (e.g., the server 150 of FIG. 1). The server 150 may receive the destination information from the turn signal control device 130, may generate route information corresponding to the destination information via the navigation system, and may transmit the route information to the turn signal control device 130.

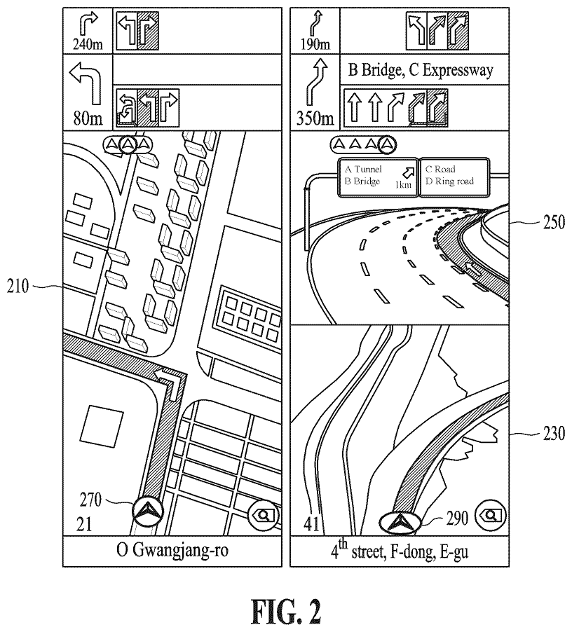

The turn signal control device 130 may identify a location where a direction change of the vehicle 110 is required, based on the route information of the vehicle 110. For example, the location where a direction change is required may include a location where a lane change is required, a left turn is required, and/or a right turn is required. A detailed description of the route information of the vehicle 110 is provided with reference to FIG. 2.

The turn signal control device 130 may control a turn signal of the vehicle 110 corresponding to the direction change, based on a distance between the location where the direction change is required and a location of the vehicle 110. The turn signal control device 130 may calculate a reference distance required for the direction change. The reference distance may need to be calculated based on various driving factors for driver safety. Hereinafter, a method of calculating the reference distance, based on a level of the driver of the vehicle 110 and/or the speed limit of a road is described.

The turn signal control device 130 may differently calculate the reference distance according to the level of the driver of the vehicle 110. The level of the driver of the vehicle 110 may be determined based on an expected time for the driver of the vehicle 110 to change the direction. For example, the level of the driver of the vehicle 110 may be determined by classifying the expected time into three stages. The expected time may be classified into 1) 40 seconds or more, 2) 20 to 40 seconds, and 3) less than 20 seconds. The level of the driver of the vehicle 110 may be determined to be a first level (e.g., a novice level or a beginner level), a second level (e.g., an intermediate level), and a third level (e.g., an advanced level), based on each stage. However, the level of the driver may be further subdivided. Hereinafter, for ease of description, it is assumed that the level of the driver is determined to be the first to third levels.

The turn signal control device 130 may differently calculate the reference distance according to the level of the driver of the vehicle 110 for the same road. For example, the turn signal control device 130 may set the reference distance according to the level of the driver to a level 2 road (e.g., a road with a speed limit of 40 km/h to 60 km/h) as Table 1 below.

TABLE 1

| | | Lane change | |
|---|---|---|---|
| Level of driver | Expected time | (40 to 60 km/h) | Left or right turn |
| First level | 40 seconds or | 1 km before | 150 m before left |
| | more | lane change | or right turn |
| Second level | 20 seconds to | 500 m before | 100 m before left |
| | 40 seconds | lane change | or right turn |
| Third level | 20 seconds or | 300 m before | 50 m before left |
| | less | lane change | or right turn |

In Table 1, for the first level, the reference distance may be set to 1 km. The turn signal control device 130 may control a turn signal 1 km before changing a lane. For example, when a distance between the location where the direction change is required (e.g., where the lane change is required) and the location of the vehicle 110 is less than 1 km, the turn signal control device 130 may activate the turn signal. Since the second level and/or the third level in Table 1 are substantially the same as the case of the first level, a description thereof is omitted.

The turn signal control device 130 may calculate the reference distance based on the speed limit of the road on which the vehicle 110 is driven. For example, the road may be classified based on the driving speed. The road may be classified into a level 0 road (e.g., a road with a speed limit of 80 km/h or above), a level 1 road (e.g., a road with a speed limit of 60 km/h to 80 km/h), a level 2 road (e.g., a road with a speed limit of 40 km/h to 60 km/h), and a level 3 road (e.g., a road with a speed limit of 40 km/h or below). The turn signal control device 130 may calculate the reference distance for each road as Table 2 below.

TABLE 2

| Level 0 road | Level 1 road | Level 2 road | Level 3 road |
|---|---|---|---|
| 80 km/h or more) | (60 to 80 km/h) | (40 to 60 km/h) | (40 km/h or less) |
| 2 kilometers | 1.5 kilometers | 1 kilometers | 0.5 kilometers |
| before the | before the | before the | before the |
| lane change | lane change | lane change | lane change |

In Table 2, for the level 0 road, the reference distance may be set to 2 km. The turn signal control device 130 may control a turn signal 2 km before changing a lane. For example, when a distance between the location where the direction change is required (e.g., where the lane change is required) and the location of the vehicle 110 is less than 2 km, the turn signal control device 130 may activate the turn signal. Since the roads (e.g., the level 1 road, the level 2 road, and/or the road) in Table 2 are substantially the same as the case of level 0 road, a description thereof is omitted.

The reference distance may be calculated using various driving factors. For example, the turn signal control device 130 may calculate the reference distance, based on the speed limit of the road and the level of the driver as Table 3 below.

TABLE 3

| | | Level 0 | | | Level 3 | |
|---|---|---|---|---|---|---|
| | | road(80 | Level 1 | Level 2 | road(40 | Left/ |
| Level of | Expected | km/h or | road(60 to | road(40 to | km/h or | Right |
| driver | time | more) | 80 km/h) | 60 km/h) | less) | turn |
| First | 40 seconds | 2 | 1.5 | 1 | 0.5 | 150 meters |
| level | or more | kilometers | kilometers | kilometers | kilometers | before a |
| | | before the | before the | before the | before the | left/right |
| | | lane | lane | lane | lane | turn |
| | | change | change | change | change | |
| Second | 20 seconds | 1.5 | 1 | 0.5 | 0.3 | 100 meters |
| level | to 40 | kilometers | kilometers | kilometers | kilometers | before a |
| | seconds | before the | before the | before the | before the | left/right |
| | | lane | lane | lane | lane | turn |
| | | change | change | change | change | |
| Third | 20 seconds | 1 | 0.5 | 0.3 | 0.15 | 50 meters |
| level | or less | kilometers | kilometers | kilometers | kilometers | before a |
| | | before the | before the | before the | before the | left/right |
| | | lane | lane | lane | lane | turn |
| | | change | change | change | change | |

In Table 3, the reference distance calculated using the reference distance calculation method described with reference to Tables 1 and 2 is shown. However, the reference distance may be calculated using driving factors other than the driving factors (e.g., the speed limit of the road and the driver's level) described above.

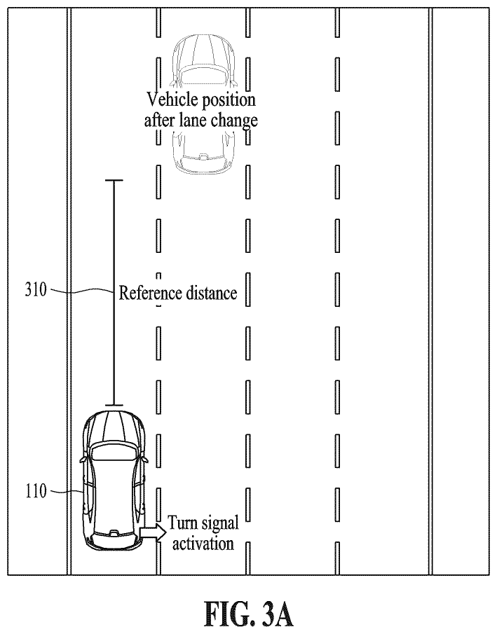

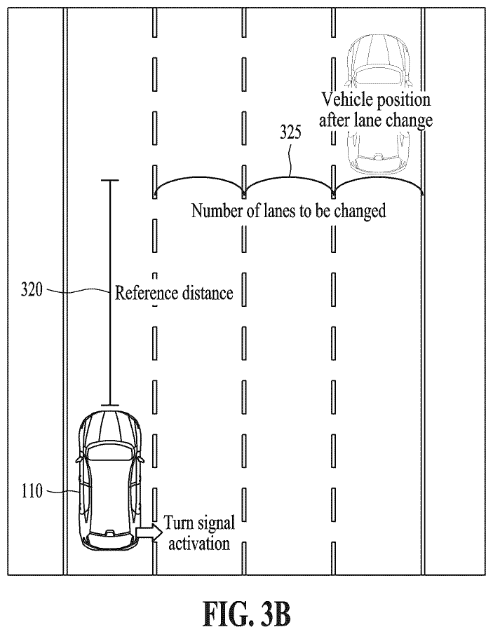

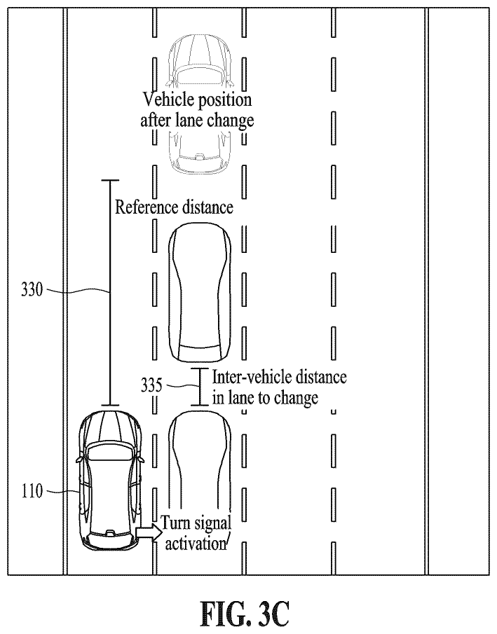

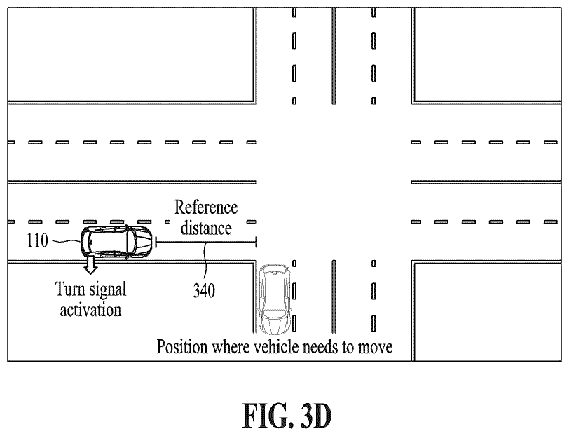

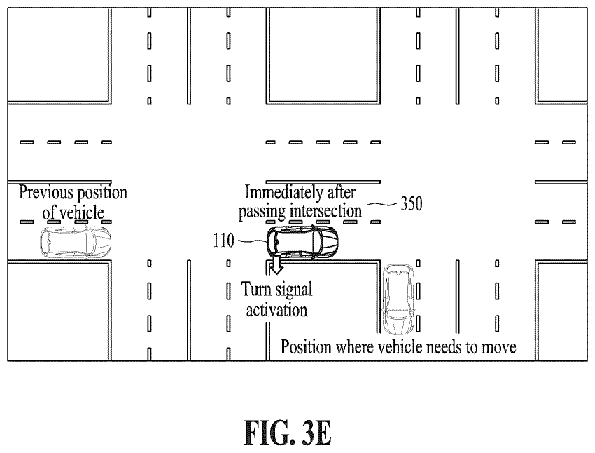

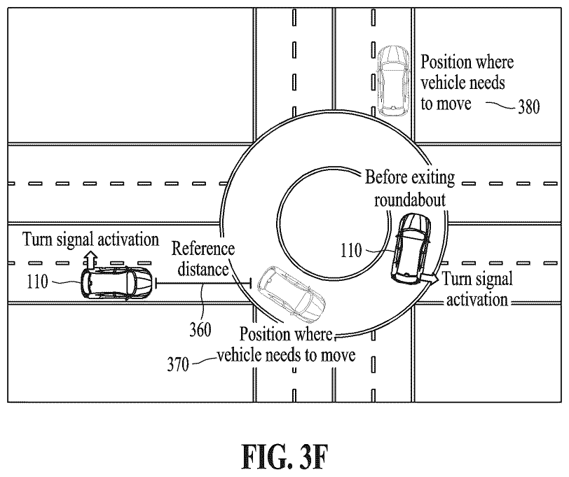

The reference distance may be calculated based on various driving factors (e.g., whether the vehicle 110 needs to change directions continuously or the level of congestion of the road on which the vehicle 110 needs to change the direction) other than the level of the driver of the vehicle 110 and the speed limit of the road on which the vehicle 110 is driven. A detailed description thereof is provided with reference to FIGS. 3A to 3F.

FIG. 2 is a diagram illustrating route information of a vehicle in a turn signal control system, according to an embodiment.

Referring to FIG. 2, screens 210 to 250 may indicate route information on a navigation system. The route information of a vehicle (e.g., the vehicle 110 of FIG. 1) may include information about a route from a location 270 of the vehicle 110 to a destination.

The vehicle 110 may require multiple direction changes to reach the destination. The direction change may be required when the vehicle 110 turns left or right and/or changes a lane. The route information may include information about a required direction change on the route from the location 270 of the vehicle 110 to the destination.

The screen 210 may show different route information from the screens 230 and 250. For example, the screen 210 may be output on one panel of the navigation system. The screens 230 and 250 may be output together on one panel of the navigation system. Hereinafter, the route information shown on each screen is described.

The screen 210 may show schematic information for the vehicle 110 to reach the destination from the location 270. For example, the route information on the screen 210 may be schematic route information about a left turn of the vehicle 110 to reach the destination.

The screen 230 may show schematic route information for the vehicle 110 to reach the destination from a location 290, and the screen 250 may show more detailed route information than the route information shown on the screen 230. For example, the route information on the screen 230 may be schematic route information indicating that the vehicle 110 goes straight to reach the destination. The screen 250 may be more detailed route information than the route information provided on the screen 230 and may show route information about changing a lane. In other words, the route information of the vehicle 110 may include not only the schematic route information, such as a left or right run and going straight, but also detailed route information about which lane to drive in.

The turn signal control device 130 may identify a location where a direction change of the vehicle 110 is required, based on the route information of the vehicle 110. The location where the direction change is required may refer to a location where the vehicle 110 needs to change its direction to reach the destination. For example, the location where the direction change is required may include a specific point (e.g., a start point of a section to change the direction) to change the direction. In another example, the location where the direction change is required may correspond to a direction change location based on turn by turn (TBT) information of the navigation system. The direction change location based on the TBT information of the navigation system may include a specific point (e.g., a start point of a section in which the vehicle that is currently driven needs to change the direction based on the TBT information) where the direction change is required.

For example, the turn signal control device 130 may identify a location where a left turn is required for the vehicle 110 to reach the destination from the location 270. The location where the left turn is required may include a start point of a section where the left turn is required. In another example, the turn signal control device 130 may identify a location where the vehicle 110 needs to change the lane to reach the destination from the location 290. The location where the lane change is required may include a start point of a section where the lane change is required.

FIGS. 3A to 3F are diagrams illustrating operations of controlling a turn signal in a turn signal control system in various scenarios.

As described with reference to FIG. 1, the reference distance may be calculated based on various driving factors (e.g., the level of the driver of the vehicle 110 and the speed limit of the road on which the vehicle 110 is driven). Hereinafter, to avoid a repeated description of the driving factors described with reference to FIG. 1, it is assumed that a scenario in FIGS. 3A to 3F is a first level and a level 2 road (e.g., the reference distance for a lane change is set to 1 km and the reference distance for a left or right turn is set to 150 m) in Table 3.

Referring to FIG. 3A, when a distance between a location (e.g., a location of the vehicle after a lane change) where a direction change is required and a location of the vehicle 110 is less than or equal to a reference distance 310, the turn signal control device 130 may activate a turn signal. For example, when the distance between the location of the vehicle after changing the lane and the location of the vehicle 110 is less than or equal to the reference distance 310 (e.g., 1 km), the turn signal control device 130 may activate the turn signal. The scenario shown in FIG. 3A may be a default scenario for a lane change. Hereinafter, a method of controlling the turn signal when a direction change (e.g., a lane change) is continuously required is described with reference to FIG. 3B.

Referring to FIG. 3B, the turn signal control device 130 may determine whether the vehicle 110 needs to change its direction continuously, based on route information. For example, the turn signal control device 130 may determine that since the number of lanes 325 to be changed is three, three direction changes are required.

When the direction change is continuously required, the turn signal control device 130 may calculate a reference distance 320, based on the number of continuous direction changes (e.g., the number of lanes to be changed 325). For example, the turn signal control device 130 may calculate the reference distance 320 (e.g., 3 km) by multiplying a reference distance (e.g., the reference distance determined based on a case of the first level and the level 2 road in Table 3) (e.g., 1 km) by the number (e.g., 3) of continuous direction changes. When a distance between the location of the vehicle after changing the lane and the location of the vehicle 110 is less than or equal to the reference distance 320 (e.g., 3 km), the turn signal control device 130 may activate the turn signal.

Hereinafter, a detailed description of a method of controlling the turn signal while the vehicle 110 changes the direction from 1 to n times according to determination that the direction needs to be changed n times is provided. However, it is assumed that the direction needs to be changed three times, for ease of description.

When a distance between a final location (e.g., a location of the vehicle 110 after changing the lane three times) and the location of the vehicle 110 is less than or equal to a reference distance (e.g., 3 km), the turn signal control device 130 may activate the turn signal. The vehicle 110 may perform an initial lane change according to the turn signal. After the initial lane change, two lane changes may be required for the vehicle 110 to reach the final location. In this case, the turn signal control device 130 may recalculate the reference distance (e.g., 2 km) as the number of required lane changes is changed (e.g., from 3 to 2). When the distance between the location of the vehicle 110 after the initial lane change and the final location is greater than or equal to the reference distance (e.g., 2 km), the turn signal may be deactivated after the initial lane change. However, when the distance between the location of the vehicle 110 after the initial lane change and the final location is less than or equal to the reference distance (e.g., 2 km), the turn signal control device 130 may continuously activate the turn signal. For example, when the distance between the location of the vehicle 110 after the initial lane change and the final location is less than or equal to the reference distance (e.g., 2 km), the turn signal control device 130 may immediately activate the turn signal without an interval for turn signal activation. However, the example is not limited thereto, and the interval for turn signal activation may be determined by additionally using the level of the driver. For example, even when the distance between the location of the vehicle 110 after the initial lane change and the final location is less than or equal to the reference distance (e.g., 2 km), if the level of the driver is the first level (e.g., the first level of Table 1), the interval for turn signal activation may be set to 2 seconds. The turn signal control device 130 may deactivate the turn signal for two seconds after the initial lane change and may activate the turn signal again. In another example, even when the distance between the location of the vehicle 110 after the initial lane change and the final location is less than or equal to the reference distance (e.g., 2 km), if the level of the driver is the second level and/or the third level (e.g., the second level and/or the third level in Table 1), the interval for turn signal activation may be set to 1 second. In other words, the turn signal control device 130 may deactivate the turn signal for 1 second after the initial lane change and may activate the turn signal again.

Since a case in which the vehicle 110 performs a second lane change according to the turn signal is substantially the same as the case of the initial lane change described above, hereinafter, a repeated description is omitted.

Hereinafter, a method of calculating a reference distance based on the level of congestion of a road on which a vehicle needs to change its direction is provided with reference to FIG. 3C.

Referring to FIG. 3C, the turn signal control device 130 may calculate a reference distance 330 based on the level of congestion of the road on which the vehicle needs to change its direction. The complexity of the road may correspond to inter-vehicle distances among vehicles on the road.

The turn signal control device 130 may calculate the reference distance 330 based on an inter-vehicle distance 335 in a lane to change.

For example, the turn signal control device 130 may determine that when the inter-vehicle distance 335 is greater than or equal to 25 m, the level of congestion of the road is in a smooth state. In the smooth state, the turn signal control device 130 may determine the reference distance 330 to be unchanged from a previous reference distance (e.g., 1 km). In another example, when the inter-vehicle distance 335 is between 10 m and 25 m, the turn signal control 130 may determine that the level of congestion of the road corresponds to a normal state. In the normal state, the turn signal control device 130 may set the reference distance 330 to 120% of the previous reference distance (e.g., 1 km). In another example, when the inter-vehicle distance 335 is between 5 m and 10 m, the turn signal control 130 may determine that the level of congestion of the road is in a congested state. In the congested state, the turn signal control device 130 may set the reference distance 330 to 150% of the previous reference distance (e.g., 1 km). In another example, when the inter-vehicle distance 335 is less than 10 m, the turn signal control device 130 may determine that the level of congestion of the road corresponds to a traffic jam state. In the traffic jam state, the turn signal control device 130 may set the reference distance 330 to 200% of the previous reference distance (e.g., 1 km).

When the distance between the location of the vehicle after changing the lane and the location of the vehicle 110 is less than or equal to the reference distance 330 (e.g., the previous reference distance (e.g., the reference distance determined based on the case of the first level and the level 2 road in Table 3) (e.g., 1 km)), the turn signal control device 130 may activate the turn signal.

Referring to FIG. 3D, when a distance between a location where a direction change is required (e.g., a location where the vehicle 110 needs to move) and a location of the vehicle 110 is less than or equal to a reference distance 340, the turn signal control device 130 may activate the turn signal. For example, when the distance between a location where the vehicle 110 needs to move by turning right and the location of the vehicle 110 is less than or equal to 150 m, the turn signal control device 130 may activate the turn signal.

The scenario shown in FIG. 3D may be a default scenario for a left or right turn. Hereinafter, a method of controlling a turn signal in a scenario in which the vehicle 110 passes two continuous intersections is described with reference to FIG. 3E.

Referring to FIG. 3E, the turn signal control device 130 may determine that a direction change (e.g., a left turn and/or a right turn) is not required at a first intersection and a direction change (e.g., a right turn) is required at a second intersection (e.g., an intersection immediately following the first intersection).

Since the case in which a distance between a location of the vehicle 110 immediately after passing the first intersection and a location (e.g., the location where the vehicle needs to move) where a direction change (e.g., a right turn) is required is greater than or equal to the reference distance (e.g., 150 m) is substantially the same as the scenario described with reference to FIG. 3D, a description thereof is omitted.

Hereinafter, a case in which a distance between a location of the vehicle 110 before passing the first intersection and a location (e.g., the location where the vehicle needs to move) where a direction change (e.g., a right turn) is required is less than the reference distance (e.g., 150 m) is described.

When the turn signal is activated for a right turn at the second intersection before the vehicle 110 passes the first intersection, surrounding drivers may misunderstand (e.g., misunderstand that the vehicle 110 will make a right turn at the first intersection). Accordingly, even when the distance between the location (e.g., the location of the vehicle 110 before the vehicle 110 passes the first intersection) of the vehicle 110 and the location (e.g., the location where the vehicle needs to move) where the direction change is required is less than the reference distance (e.g., 150 m), the turn signal control device 130 may not activate the turn signal. The turn signal control device 130 may activate the turn signal immediately after the vehicle 110 passes the first intersection.

In the case of three or more continuous intersections, the turn signal may be controlled in the substantially same method as the case of two continuous intersections. For example, even for a scenario in which there are three continuous intersections (e.g., the first, second, and third intersections are continuous intersections, and the vehicle 110 passes the first, second, and third intersections sequentially), even when a distance between a location of the vehicle 110 before passing the first intersection and/or the second intersection and a location (e.g., a location where the vehicle needs to turn left and/or right at the third intersection) where a direction change is required is less than or equal to the reference distance, the turn signal control device 130 may activate the turn signal immediately after the vehicle 110 passes the second intersection.

Hereinafter, a method of controlling a turn signal in a roundabout is described with reference to FIG. 3F.

Referring to FIG. 3F, a case in which the vehicle 110 enters a roundabout is described. When a distance between a location (e.g., a location 370 where the vehicle needs to move as the vehicle enters the roundabout) where the vehicle 110 needs to change its direction and a location of the vehicle 110 is less than or equal to a reference distance 360 (e.g., 150 m), the turn signal control device 130 may activate the turn signal. This may be substantially the same as the method of FIG. 3D.

After the vehicle 110 enters the roundabout, the turn signal control device 130 may activate the turn signal before exiting the roundabout. For example, in a scenario of exiting the roundabout, the turn signal control device 130 may calculate the reference distance based on a distance between a exit road (e.g., a location 380 where the vehicle needs to move as the vehicle exits the roundabout) and another road connected to the roundabout. The turn signal control device 130 may determine a distance between the exit road and a road located immediately before the road from which the vehicle 110 is to exit to be the reference distance. When the vehicle 110 enters the road located immediately before the road from which the vehicle 110 is to exit on the roundabout, the turn signal control device 130 may activate the turn signal.

In the scenarios of FIGS. 3A to 3F, when the vehicle 110 changes its direction according to the turn signal, the turn signal control device 130 may deactivate the activated turn signal. When the vehicle 110 does not change its direction according to the turn signal, the turn signal control device 130 may reidentify a location where the direction change of the vehicle 110 is required based on the changed route information and may control the turn signal. For example, the route information may be changed as the route from the location of the vehicle 110 to the destination changes when the vehicle 110 does not change its direction according to the turn signal. The turn signal control device 130 may perform the method of controlling the turn signal, described with reference to FIGS. 1 to 3F, substantially in the same manner based on the changed route information.

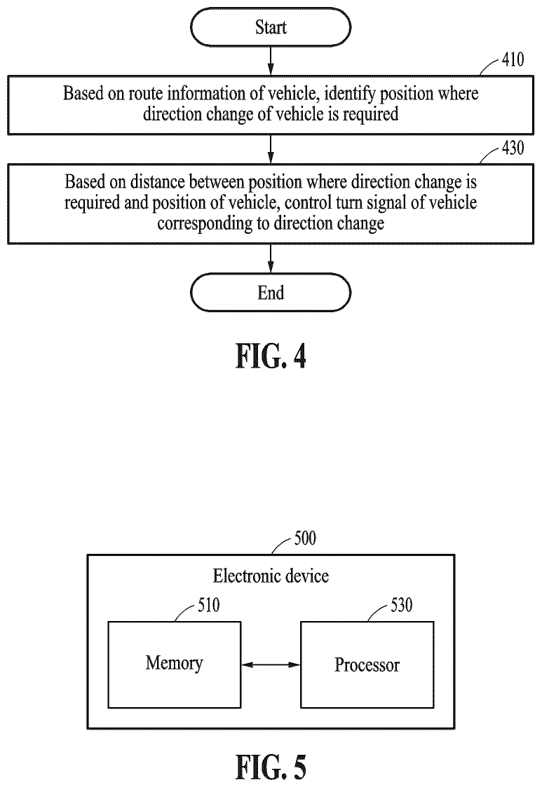

FIG. 4 is an example of a flowchart of a method of controlling a turn signal in a turn signal control system according to an embodiment.

Referring to FIG. 4, operations 410 and 430 may be performed sequentially, but the example is not limited thereto. For example, two or more operations may be performed in parallel. Operations 410 to 430 may be substantially the same as the operations of the turn signal control device (e.g., the turn signal control device 130 of FIG. 1) described with reference to FIGS. 1 to 3F. Accordingly, a detailed description will be omitted.

In operation 410, the turn signal control device 130 may identify a location where the vehicle 110 needs to change its direction based on route information of the vehicle 110. The route information of the vehicle 110 may be obtained based on a navigation system.

The turn signal control device 130 may calculate a reference distance required for the direction change. For example, the turn signal control device 130 may differently calculate the reference distance depending on a level of a driver of the vehicle 110. The level of the driver of the vehicle 110 may be determined based on an expected time for the driver of the vehicle 110 to change the direction. In another example, the turn signal control device 130 may calculate the reference distance based on the speed limit of the road on which the vehicle 110 is currently driven. In another example, the turn signal control device 130 may determine whether the direction change of the vehicle 110 is continuously required, based on the route information. When the direction change is continuously required, the turn signal control device 130 may calculate the reference distance based on the number of continuous direction changes. In another example, the turn signal control device 130 may calculate the reference distance based on the level of congestion of the road on which the vehicle 110 changes its direction.

When the distance between the location where the direction change is required and the location of the vehicle 110 is less than or equal to the reference distance, the turn signal control device 130 may activate the turn signal.

In operation 430, the turn signal control device 130 may control a turn signal of the vehicle 110 corresponding to the direction change, based on a distance between the location where the direction change is required and the location of the vehicle 110.

When the vehicle 110 does not change its direction according to the turn signal, the turn signal control device 130 may reidentify a location where the direction change of the vehicle 110 is required based on the changed route information. The turn signal control device 130 may control the turn signal corresponding to the reidentified direction change based on the distance between the reidentified location where the direction change is required and the location of the vehicle 110. Since detailed operations thereof are substantially the same as operations 410 and 430, a detailed description is omitted.

FIG. 5 is an example of an electronic device in a turn signal control system according to an embodiment.

Referring to FIG. 5, an electronic device 500 may include a memory 510 and a processor 530. The electronic device 500 may include the turn signal control device 130 and/or the server 150 of FIG. 1.

The memory 510 may store instructions (or programs) executable by the processor 530. For example, the instructions include instructions for performing the operation of the processor 530 and/or an operation of each component of the processor 530.

The memory 510 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, or insulator resistance change memory.

The processor 530 may process data stored in the memory 510. The processor 530 may process data stored in the memory 510. The processor 530 may execute computer-readable code (for example, software) stored in the memory 510 and instructions triggered by the processor 530.

The processor 530 may be a data-processing device implemented by hardware including a circuit having a physical structure to perform desired operations. For example, the desired operations may include code or instructions in a program.

For example, the data-processing device implemented by hardware may include a microprocessor, a central processing unit (CPU), a processor core, a multi-core processor, a multiprocessor, an application-specific integrated circuit (ASIC), and a field-programmable gate array (FPGA).

The processor 530 may cause the electronic device 500 to perform one or more operations by executing code and/or instructions stored in the memory 510. The operations performed by the electronic device 500 may be substantially the same as the operations performed by the turn signal control device 130 described with reference to FIGS. 1 to 4. Accordingly, a repeated description is omitted.

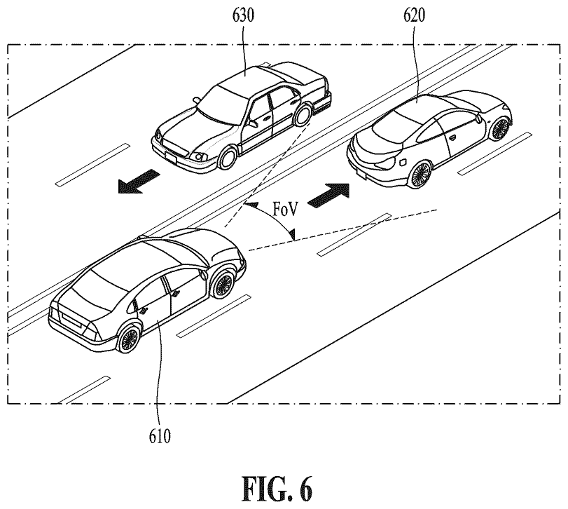

FIGS. 6 to 8 are diagrams illustrating an autonomous driving scheme in a notification providing system according to an embodiment.

Referring to FIG. 6, an autonomous driving device according to an embodiment of the present disclosure may be installed in a vehicle to implement an autonomous vehicle 610. The autonomous driving device installed in the autonomous vehicle 610 may include various sensors to collect information on a surrounding situation. For example, the autonomous driving device may sense a movement of a preceding vehicle 620 that is driven in front of the autonomous vehicle via an image sensor and/or an event sensor mounted on the front of the autonomous vehicle 610. The autonomous driving device may further include sensors to sense another driving vehicle 630 in a next lane and pedestrians around the autonomous vehicle 610 in addition to the front of the autonomous vehicle 610.

At least one of the sensors to collect the information on the surrounding situation of the autonomous vehicle may have a predetermined field of view (FoV) as shown in FIG. 6. For example, when the sensor mounted on the front of the autonomous vehicle 610 has the FoV as shown in FIG. 6, information sensed from the center of the sensor may have relatively high importance. This may be because the information sensed from the center of the sensor includes information corresponding to the movement of the preceding vehicle 620.

The autonomous driving device may process the information collected by the sensors of the autonomous vehicle 610 in real-time, may control the movement of the autonomous vehicle 610, and may store at least a portion of the information collected by the sensors in a memory device.

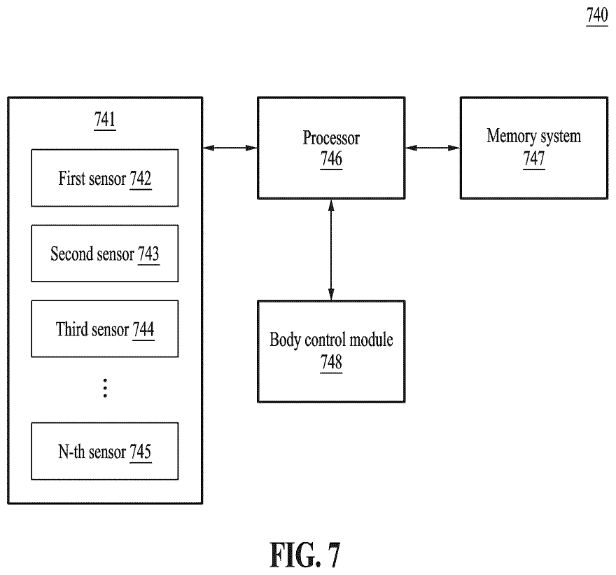

Referring to FIG. 7, an autonomous driving device 740 may include a sensor unit 741, a processor 746, a memory system 747, and a body control module 748. The sensor unit 741 may include a plurality of sensors 742 to 745, and the plurality of sensors 742 to 745 may include an image sensor, an event sensor, an illuminance sensor, a global positioning system (GPS) device, and/or an acceleration sensor.

The data collected by the sensors 742 to 745 may be transmitted to the processor 746. The processor 746 may store the data collected by the sensors 742 to 745 in the memory system 747 and may determine a movement of the vehicle by controlling the body control module 748 based on the data collected by the sensors 742 to 745. The memory system 747 may include two or more memory devices and a system controller for controlling the memory devices. Each of the memory devices may be provided as a single semiconductor chip.

Other than the system controller of the memory system 747, each of the memory devices included in the memory system 747 may include a memory controller, and the memory controller may include artificial intelligence (AI) computation circuitry such as a neural network. The memory controller may generate computation data by assigning a weight to the data received from the sensors 742 to 745 or the processor 746 and may store the computation data in the memory chip.

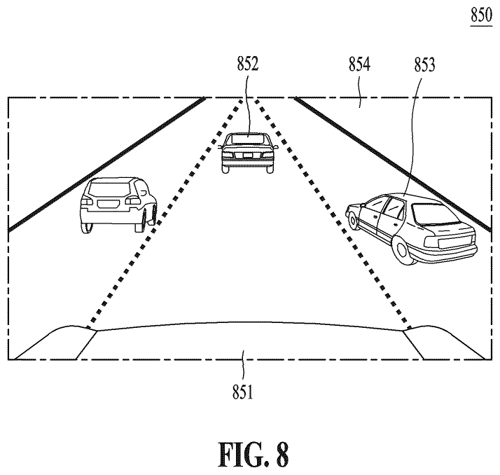

FIG. 8 is a diagram illustrating an example of image data obtained by a sensor of an autonomous vehicle equipped with an autonomous driving device. Referring to FIG. 8, image data 850 may be data obtained by a sensor mounted on the front of the autonomous vehicle. Accordingly, the image data 850 may include a front portion 851 of the autonomous vehicle, a preceding vehicle 852 in the same lane as the autonomous vehicle, a driving vehicle 853 around the autonomous vehicle, and a region of no interest (RONI) 854.

In the image data 850 according to the embodiment shown in FIG. 8, data on a region showing the front portion 851 of the autonomous vehicle and the RONI 854 may be data that has little possibility of affecting the operation of the autonomous vehicle. In other words, the front portion 851 of the autonomous vehicle and the RONI 854 may be regarded as data having relatively low importance.

On the other hand, a distance from the preceding vehicle 852 and a movement of the driving vehicle 853 to change a lane may be important factors in the safe operation of the autonomous vehicle. Accordingly, in the image data 850, data on a region including the preceding vehicle 852 and the driving vehicle 853 may have relatively high importance in the operation of the autonomous vehicle.

The memory device of the autonomous vehicle may assign different weights to regions in the image data 850 received from the sensor and may store the image data 850. For example, a high weight may be assigned to the data on the region including the preceding vehicle 852 and the driving vehicle 853, and a low weight may be assigned to the data on the region showing the front portion 851 of the autonomous vehicle and the RONI 854.

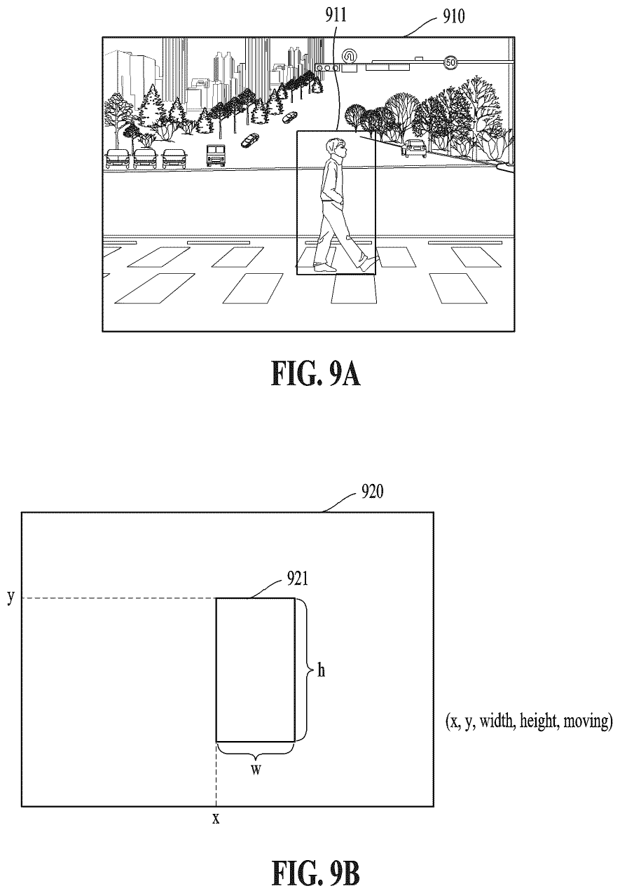

FIGS. 9A and 9B are diagrams related to a camera that captures the outside of a vehicle in a notification providing system according to an embodiment.

The camera may be mounted on the vehicle and may capture the outside of the vehicle. The camera may capture the front, sides, and rear of the vehicle. A device according to an embodiment may obtain a plurality of images captured by the camera. A plurality of objects may be included in the plurality of images captured by the camera.

Information on the object may include object type information and object property information. In this case, the object type information may be index information indicating a type of the object and may include a broad category called a group and a detailed category called a class. In addition, the object property information may indicate property information about a current state of the object and may include movement information, rotation information, traffic information, color information, and visibility information.

In an embodiment, the group and class included in the object type information may be as shown in Table 4, but the example is not limited thereto.

TABLE 4

| Group | Class |
|---|---|
| Flat | Road, Sidewalk, Parking, Ground, Crosswalk |
| Human | Pedestrian, Rider |
| Vehicle | Car, Truck, Bus |
| Construction | Building Wall, Guard rail, Tunnel, Fence, Gas station, |
| | Pylon |
| Object | Pole, Traffic sign, Traffic light, Color corn |
| Nature | Vegetation, Terrain, Paddy field, River, Lake |
| Void | Static |
| Lane | Dotted line, Solid line, Dotted and Solid line, Double |
| | solid line |
| Sky | Sky |
| Animal | Dog, Cat, Bird |

The movement information may represent information about a movement of the object and may be defined as stopping, parking, and moving. For a vehicle, stopping, parking, and moving may be determined to be the object property information, and for a pedestrian, moving, stopping, unknown may be determined to be the object property information. For an object that is unable to move, such as a traffic light, stopping, which is a default value, may be determined to be the object property information. The rotation information may represent information about rotation of the object and may be defined as front, rear, horizontal, vertical, and side. For the vehicle, front, rear, side may be determined to be the object property information, and a horizontal or vertical traffic light may be determined to be horizontal or vertical.

The traffic information may be traffic information of the object and may be defined as an instruction, a caution, a regulation, and an auxiliary sign of a traffic sign. The color information may be information about a color of the object and may represent a color of the object, a traffic light, and a traffic sign.

Referring to FIG. 9A, an object 911 may be a pedestrian. An image 910 may have a predetermined size. The same object 911 may be included in a plurality of images 910, but a position of the object 911 relative to the vehicle continuously may change because the vehicle is driven on the road and the object 911 may also move over time, and accordingly, the position of the object 911 may vary in each image.

When the entire image is used to determine what is the same object in each image, the amount of data transfer and computation may significantly increase. Accordingly, it may be difficult to process the data by edge computing in the device mounted on the vehicle and real-time analysis may also be difficult.

Referring to FIG. 9B, a bounding box 921 included in an image 920 is illustrated. The bounding box may be metadata about an object, and bounding box information may include object type information (a group, a class, etc.), information about a position in the image 920, and size information.

Referring to FIG. 9B, the bounding box information may include information that the object 911 corresponds to a pedestrian class, information that an upper left vortex of the object 911 is positioned at (x, y) on the image, information that the size of the object 911 is w×h, and current state information (e.g., the movement information) that the object 911 is moving.

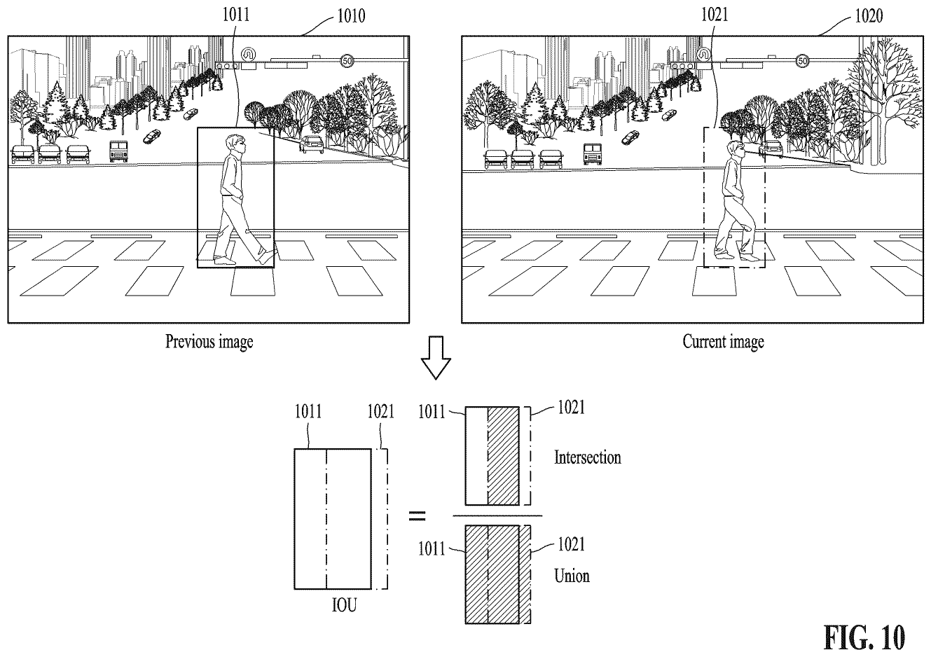

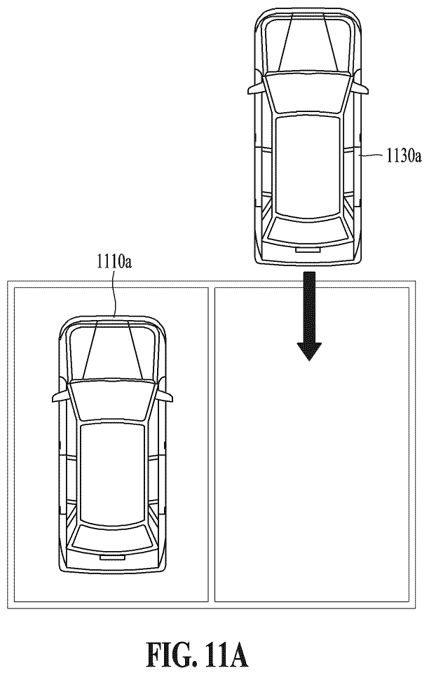

FIG. 10 is a schematic diagram illustrating an object detection method in a notification providing system according to an embodiment.

An object detection device may obtain a plurality of frames by dividing a video obtained by the camera into frames. The plurality of frames may include a previous frame 1010 and a current frame 1020.

The object detection device may detect a first pedestrian object 1011 in the previous frame 1010.

In an embodiment, the object detection device may divide the frame into grids having the same size, may predict the number of bounding boxes determined in a predefined shape based on the grid center for each grid, and may calculate a confidence based on the expected bounding boxes. The object detection device may determine whether the object is included in the frame or whether only a background is included in the frame and may consequentially detect the object by determining an object category by selecting a position having a high object confidence. However, the method of detecting the object in the present disclosure is not limited thereto.

The object detection device may obtain first position information of the first pedestrian object 1011 detected in the previous frame 1010. As described above with reference to FIGS. 9A and 9B, the first position information may include coordinate information about a vortex (e.g., the upper left vortex) of a bounding box corresponding to the first pedestrian object 1011 in the previous frame 1010 and horizontal and vertical length information.

In addition, the object detection device may obtain second position information of a second pedestrian object 1021 detected in the current frame 1020.

The object detection device may compute a similarity between the first position information of the first pedestrian object 1011 detected in the previous frame 1010 and the second position information of the second pedestrian object 1021 detected in the current frame 1020.

Referring to FIG. 10, the object detection device may compute an intersection and a union between the first pedestrian object 1011 and the second pedestrian object 1021 using the first position information and the second position information. The object detection device may compute a value of an intersection area compared to a union area. When the computed value is greater than or equal to a threshold value, the object detection device may determine that the first pedestrian object 1011 is the same pedestrian object as the second pedestrian object 1021.

However, the method of determining identity between objects is not limited thereto.

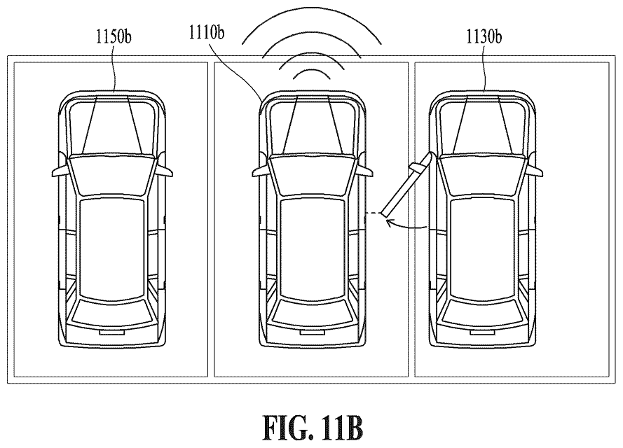

FIG. 11A is a diagram illustrating a case in which another vehicle is parked next to a parked vehicle in a notification providing system as a situation to which an embodiment of the present disclosure is applied.

Hereinafter, unless specifically limited, a first vehicle may be regarded as a vehicle providing a notification to the outside when a specific condition is met in a parked state, and a second vehicle may be regarded as a vehicle that causes or may cause the first vehicle to provide a notification.

More specifically, FIG. 11A illustrates a case in which a second vehicle 1130a is parked next to a first vehicle 1110a that is parked. In this case, a gap between the first vehicle 1110a and the second vehicle 1130a is not sufficient, after the second vehicle 1130a is parked, while opening a door on the driver's side of the second vehicle 1130a, the first vehicle 1110a may be damaged because the second vehicle 1130a contacts the first vehicle 1110a.

According to an embodiment, the first vehicle 1110a may provide a notification to the second vehicle 1130a to prevent the contact.

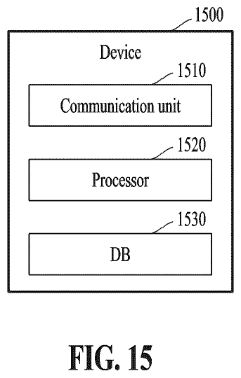

Hereinafter, a device for implementing the method according to the present disclosure may be referred to as an external notification device, and the external notification device may be included in the first vehicle 1110a. In FIG. 11A, the external notification device is not separately illustrated, and a sub-module constituting the external notification device is described with reference to FIG. 15.

The external notification device of the first vehicle 1110a may determine whether the second vehicle 1130a meets a first condition to provide a notification to the second vehicle 1130a.

In this case, the first condition may be a condition related to a movement of the second vehicle 1130a. In more detail, the first condition may be a condition including two subconditions. For example, the first condition may be a condition that is met when both first and second subconditions are met.

Meanwhile, the first subcondition of the first condition may determine whether at least one of optical camera communication (OCC)-based devices mounted on the first vehicle 1110a has detected the second vehicle 1130a that is moving. More specifically, the first subcondition of the first condition may be determining that the external notification providing system of the first vehicle 1110a has detected the second vehicle 1130a that is moving using the OCC-based devices installed at the front, rear, and sides of the first vehicle.

In this case, OCC-based technology used to determine whether the first subcondition of the first condition is met may be one of communication technologies using light and may be used for information exchange between vehicles or for communication between vehicles and infrastructure. For example, the infrastructure may include a traffic light and a light-emitting diode (LED) road sign. In addition, the OCC-based technology herein may be implemented by transmitting data using light from a headlight, a brake light, and an LED display of the vehicle and interpreting the information as the camera sensor receives the data.

Referring to FIG. 11A, cameras mounted on the front, rear, and sides of the first vehicle may detect the second vehicle 1130a that is moving around the first vehicle 1110a based on the OCC and may transmit a detection result to the external notification device. For example, when the camera sensor mounted on the first vehicle 1110a receives light from the second vehicle 1130a, the external notification device may detect the second vehicle 1130a using a sensing value of the camera sensor. In this case, it may be assumed that a black box of the first vehicle 1110a is activated to determine the first subcondition of the first condition.

In this case, when the first subcondition of the first condition is met, the external notification device of the first vehicle 1110a may determine whether a movement of the second vehicle 1130a is detected around the first vehicle 1110a. Meanwhile, when the first subcondition of the first condition is met, a proximity sensor of the first vehicle 1110a may be activated. According to an embodiment of the present disclosure, a second subcondition of the first condition may be determined using the proximity sensor of the first vehicle 1110a that is activated when the movement of the second vehicle 1130a is detected. In this case, based on the front, rear, and sides of the first vehicle 1110a, if the first subcondition of the first condition is a condition for detect a moving body of which a position varies over time and selectively activating the proximity sensor, the second subcondition of the first condition may be a condition for determining whether the detected moving body approaches within a preset range from the first vehicle 1110a.

Meanwhile, the proximity sensor may be one of an ultrasonic sensor or radio detection and ranging (RADAR). The ultrasonic sensor may calculate a distance from an object by transmitting ultrasonic waves and measuring the time taken for the transmitted ultrasonic waves to reflect off the object and return. In addition, the radar may calculate a distance from the object by transmitting electromagnetic waves and measuring the time taken for the electromagnetic waves to reflect off the object and return. The proximity sensor may be used to determine whether the movement of the second vehicle 1130a is detected around the first vehicle 1110a.

In an example, the proximity sensor of the first vehicle 1110a may detect the movement of the second vehicle 1130a within 0.6 m of the first vehicle 1110a. However, the range in which the proximity sensor of the first vehicle 1110a detects the movement of the second vehicle 1130a is not limited thereto. In addition, the range for detecting the movement of the second vehicle 1130a may reflect a door opening length of the first vehicle 1110a.

The first and second subconditions included in the first condition may be conditions (e.g., compound conditions) that both conditions need to be met to consider that the first condition is met. More specifically, after the first subcondition of the first condition is met, whether the second subcondition is met may be determined.

When the first condition is met, the external notification device of the first vehicle 1110a may determine whether a second condition is met. In this case, the second condition that is determined to be a subsequent condition of the first condition may include a plurality of subconditions, and since the subconditions included in the second condition are not interrelated unlike the subconditions included in the first condition, when at least one of the plurality of subconditions of the second condition is met, it may be determined that the second condition is met. In addition, the second condition may correspond to an execution condition for a parked vehicle to provide a notification to the outside.

As one of the plurality of second conditions, the external notification device of the first vehicle 1110a may determine whether the second vehicle 1130a attempts to park on one side of the first vehicle 1110a.

For example, the first vehicle 1110a may determine whether the movement of the second vehicle 1130a that attempts to park on one side of the first vehicle 1110a is detected and the rear or front of the second vehicle 1130a passes a midpoint of the first vehicle 1110a.

In this case, to meet the condition described above, the midpoint of the first vehicle 1110a that the rear or front of the second vehicle 1130a may be near the B pillar of the first vehicle 1110a. Specifically, the B pillar of the vehicle, which is the determination criterion of the external notification device, may be a pillar between front and rear seats of the vehicle and may refer to a portion that forms a boundary between front and rear doors. However, the midpoint, which is a criterion for the external notification device to determine whether a condition is met, is not limited to the B pillar of the vehicle, and depending on the embodiment, the criterion may vary.

In addition, when the front or rear of the second vehicle 1130a passes the midpoint of the first vehicle 1110a, the external notification device of the first vehicle 1110a may determine whether the movement of the second vehicle 1130a is recognized on an entirety of the one side of the first vehicle 1110a.

More specifically, the external notification device of the first vehicle 1110a may determine whether the front or rear of the second vehicle 1130a that attempts to park on one side of the first vehicle 1110a passes the midpoint of the first vehicle 1110a, and when the front or rear of the second vehicle 1130a passes the midpoint of the first vehicle 1110a, the external notification device of the first vehicle 1110a may determine whether the movement of the second vehicle 1130a is recognized on the entire one side of the first vehicle 1110a.

Meanwhile, when the first condition and the second condition are met, the first vehicle 1110a may provide a notification to the outside. A detailed description of the notification is provided below.

FIG. 11B is a diagram illustrating a case in which, after another vehicle is parked next to a parked vehicle, a door is open in a notification providing system as a situation to which an embodiment of the present disclosure is applied.

More specifically, in FIG. 11B, a second vehicle 630b parked on the right side of a first vehicle 1110a, which is a parked vehicle, and a third vehicle 1150b parked on the left side of the first vehicle 1110a are illustrated. Similar to the situation in FIG. 11A, when a gap between parked vehicles is insufficient, the vehicle that is parked first may be damaged while a driver of the vehicle that is parked later opens the door of the vehicle that is parked later.

Specifically, it may be assumed that the first vehicle 1110b is damaged while the user of the second vehicle 630b that is parked on the right side of the first vehicle 1110b opens the door. According to an embodiment, an external notification device of the first vehicle 1110b may provide a notification to the user of the second vehicle 630b to prevent damage to the first vehicle 1110b. In this case, the external notification device of the first vehicle 1110b may determine whether a first condition that is preset to the external notification device is met to provide an external notification.

Similar to FIG. 11A, the first condition may be related to the movement of the second vehicle 630b. The first condition may include two subconditions and may be met when both subconditions are met. In this case, a first subcondition of the first condition may be that the external notification device determines whether the second vehicle 630b is detected via an OCC-based device installed on the front, rear, or side of the first vehicle 1110b, and a second subcondition of the first condition may be that a proximity sensor that is activated as the first subcondition is met determines whether the movement of the second vehicle 630b is detected around (e.g., within a preset distance) the first vehicle 1110b. In an embodiment, the range for detecting the movement of the second vehicle 630b in the second subcondition of the first condition may be within 0.6 m of the first vehicle 1110b, but the range is not limited thereto. In addition, the type of sensor for determining whether the condition is met may vary and is not limited to the type of sensor described above.

When the first condition is met, the first vehicle 1110b may determine whether the second condition is met. In this case, there may be multiple second conditions determined to be subsequent conditions of the first condition, and at least one of the second conditions is met, it may be determined that the second condition is met. In addition, the second condition may correspond to an execution condition for a parked vehicle to provide a notification to the outside.

Referring to FIG. 11B, as one of the second conditions, the external notification device of the first vehicle 1110b may determine whether a door of the vehicle parked on the side of the vehicle 1110b is open. Although FIG. 11B illustrates a situation in which the door of the second vehicle 630b that is parked on the right side of the first vehicle 1110b is open, the vehicle parked on one side of the first vehicle 1110b does not necessarily need to be parked on the right side of the first vehicle 1110b to execute the second condition, and the first vehicle 1110b may determine whether the door of the vehicle parked on one side of the first vehicle 1110b is open regardless of the left or right side of the first vehicle 1110b. According to an embodiment, the external notification device of the first vehicle 1110b may determine whether an opening of the door of the second vehicle 630b is recognized to prevent damage to the first vehicle 1110b when there is a person inside the second vehicle 630b and the door is open. In this case, the external notification device of the first vehicle 1110b may recognize the opening of the door of the vehicle parked on one side of the first vehicle 1110b via an OCC-based device installed on the side of the first vehicle 1110b. More specifically, the external notification device of the first vehicle 1110b may recognize the opening of the door of the second vehicle 630b via the OCC-based device installed on the right side of the first vehicle 1110b to prevent damage to the first vehicle 1110b that may occur when a passenger inside the second vehicle 630 that is parked on the right side of the first vehicle 1110b opens the door of the second vehicle 630b. Similarly, when the second vehicle 630 is parked on the left side of the first vehicle 1110b and the passenger of the second vehicle 630b opens the door of the second vehicle 630b, the OCC-based device installed on the left side of the first vehicle 1110b may recognize the opening of the door of the second vehicle 630b.

In addition, the proximity sensor of the first vehicle 1110b may recognize an opening of a door of a vehicle parked on one side of the first vehicle 1110b. In this case, according to an embodiment, an ultrasonic sensor or radar may be used as the proximity sensor. Specifically, when a value of the proximity sensor is changed, the external notification device of the first vehicle 1110b may determine that the door of the vehicle parked on one side of the first vehicle 1110b is open. Meanwhile, the sensor for detecting the opening of the door of the vehicle parked on one side of the first vehicle 1110b is not limited thereto.

In this case, when the external notification device of the first vehicle 1110b detects the opening of the door of the vehicle parked on one side of the first vehicle 1110b as one of the plurality of second conditions, the second condition may be met, and a notification may be provided to the outside of the first vehicle 1110b. A detailed method of providing a notification to the outside by the external notification device of the first vehicle 1110b is described below.

Meanwhile, the case in which the external notification device of the first vehicle 1110b provides a notification to the outside of the first vehicle 1110b may include a case in which a user of the vehicle that is parked on one side of the first vehicle 1110b gets in the vehicle that is parked on one side of the first vehicle 1110b. To prevent damage to a vehicle that may occur in this case, the external notification device of the first vehicle 1110b may detect a movement of a moving body that approaches the vehicle parked on one side of the first vehicle 1110b. Herein, the moving body may include both a person and an object, and since the external notification device according to the present disclosure is designed to prevent a parked vehicle from being damaged by the moving body, only a moving body that does not yet contact the first vehicle 1110b, which is a parked vehicle, may be regarded as the moving body to trigger an external notification.

More specifically, as one of the plurality of second conditions that are external notification execution conditions, the external notification device of the first vehicle 1110b may determine whether the movement of the moving body that approaches the vehicle parked on the left or right side of the first vehicle 1110b is recognized on the entire left or right side of the first vehicle 1110b.

Meanwhile, when the movement of the moving body is recognized from the front or rear of the first vehicle 1110b, the possibility of damage occurring due to the opening of the door of the vehicle parked on one side of the first vehicle 1110b may be low. Accordingly, according to an embodiment, the external notification device of the first vehicle 1110b may determine whether the second condition is met except for a case in which the movement of the moving body is detected from the front or rear of the first vehicle 1110b.

Referring to FIG. 11B, the external notification device of the first vehicle 1110b may provide an external notification to prevent damage to the first vehicle 1110b that may occur when the third vehicle 1150b parked on the left side of the first vehicle 1110b exits. According to an embodiment, the external notification device of the first vehicle 1110b may determine that the second condition is met when the movement of a user of the third vehicle that approaches the third vehicle 1150b is detected on the entire left side of the first vehicle 1110b. In addition, although not shown in FIG. 11B, according to an embodiment, when the third vehicle 1150b is parked on the right side of the first vehicle 1110b and the user of the third vehicle approaches the third vehicle 1150b, if the movement of the user of the third vehicle is detected on the entire right side of the first vehicle 1110b, the external notification device of the first vehicle 1110b may determine that the second condition is met. Meanwhile, the subject of the movement recognized over an entirety of one side of the first vehicle 1110b is not limited to a person, and according to an embodiment of the present disclosure, the external notification device of the first vehicle 1110b may also determine that the second condition is met when the movement of an object approaching the vehicle that is parked on one side of the first vehicle 1110b is detected on the entirety of one side of the first vehicle 1110b.

Similarly, when the second condition is met, the external notification device of the first vehicle 1110b may provide a notification to the outside. A detailed method of providing a notification to the outside by the external notification device of the first vehicle 1110b is described below.

Meanwhile, although not shown in FIG. 11B, the external notification device of the first vehicle 1110b may provide an external notification to prevent damage to the first vehicle that may be caused by a motorcycle, a bicycle, or a cart around the first vehicle 1110b. In this case, the external notification device of the first vehicle 1110b may determine whether an object or person is recognized or a movement of the object or person is detected within an adjacent distance of one side of the first vehicle 1110b.

More specifically, when the movement of the moving body is detected on the entirety of one side of the first vehicle 1110b, the external notification device of the first vehicle 1110b may determine that the second condition is met. In addition, when the moving condition is detected on the entirety of one side of the first vehicle 1110b, the external notification device of the first vehicle 1110b may determine that the second condition is met. Meanwhile, when the second condition is met, the external notification device of the first vehicle 1110b may provide a notification to the outside.

As described above, when one of a plurality of second conditions is met, the external notification device of the first vehicle 1110b that is parked may provide a notification to the outside of the first vehicle 1110b. According to an embodiment, the external notification device of the first vehicle 1110b may use a vehicle exterior lighting to provide a notification to the outside of the first vehicle 1110b. In this case, the vehicle exterior lighting may refer to a lighting of the first vehicle 1110b, and the vehicle exterior lighting may include a daytime running lamp, a headlight, and a taillight.

Meanwhile, according to an embodiment of the present disclosure, turning on the taillight to provide a notification may be intended to give an impression that a person is present inside the vehicle. In addition, according to an embodiment of the present disclosure, an autolight function may be applied when turning on the taillight for the first vehicle 1110b provide a notification to the outside. In this case, the autolight function may refer to a function to automatically turn on or off the lighting of the vehicle based on a driving condition and may be a function to control the lighting according to the brightness of the surrounding environment using an illuminance sensor. According to an embodiment of the present disclosure, the external notification device of the first vehicle 1110b may turn on a driving light of the first vehicle 1110b to provide a notification to the outside and may turn on the headlight and the taillight together depending on the brightness of the surrounding environment using the autolight function.

In addition, the notification may be provided to the outside using door locking sound. In this case, the door locking sound may be sound that occurs when the door of the vehicle is locked or unlocked. More specifically, the external notification device of the first vehicle 1110b may provide the notification to the outside of the first vehicle 1110b via sound that occurs when the door of the vehicle is open. Meanwhile, according to an embodiment, the external notification device of the first vehicle 1110b may provide the notification to the outside by turning a hazard light of the first vehicle 1110b on and off once, similar to when unlocking the door of the vehicle.

Meanwhile, the external notification device of the first vehicle 1110b may provide the notification to the outside in various manners, and the example is not limited thereto.

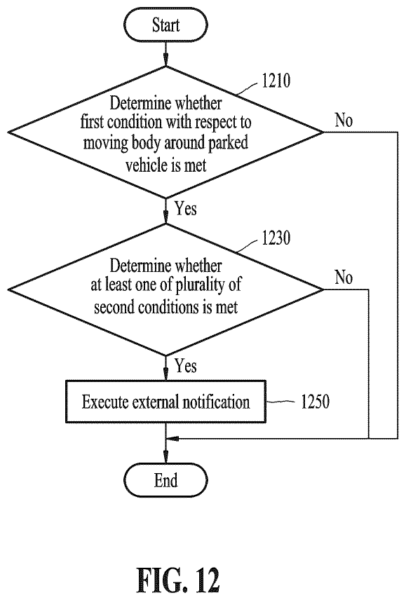

FIG. 12 is a flowchart of a method of providing a notification to the outside by a parked vehicle in a notification providing system according to an embodiment.

More specifically, according to an embodiment of the present disclosure, a method of providing a notification to the outside by a parked vehicle may be provided, wherein the method includes that an external notification device of the parked vehicle may determine 1210 whether a first condition with respect to a moving body around the parked vehicle is met using a sensor thereof, and when the first condition is met, the external notification device may determine 1230 whether at least one of a plurality of second conditions for executing an external notification is met, and when one of the second conditions is met, the external notification device may execute 1250 the external notification.

According to an embodiment, when the vehicle is in a parked state, the external notification device of the vehicle may determine 1210 whether the first condition with respect to the moving body around the parked vehicle is met using the sensor of the parked vehicle. in this case, the parked state may refer to a case in which a door of the vehicle is locked, but is not limited thereto.

Meanwhile, the user may set an exclusion location for the parked vehicle not to provide a notification to the outside. More specifically, at the location designated by the user, the external notification device of the vehicle may not determine whether the first condition is met even if the vehicle is in the parked state.

Meanwhile, the user may set the exclusion location via detailed settings. More specifically, the user may designate the exclusion location in advance, such as a garage of the user, so that the vehicle does not provide an external notification at the location where the external notification is not needed because other vehicles may not be parked near the user's vehicle. Meanwhile, the user may set the exclusion location from a list of bookmarked locations by executing the external notification device, and according to an embodiment, the user may set a current location as the exclusion location.

Since the present disclosure is designed to prevent damage to the user's vehicle that is parked by providing an external notification to a vehicle that is parked or exiting near the user's vehicle, when the user is already in the vehicle or immediately after getting in the vehicle, the external notification device of the parked vehicle may not determine whether the first condition is met. In addition, while the external notification device executes the external notification as the first and second conditions are met, when the user gets in the parked vehicle, the external notification may be immediately terminated.

Meanwhile, the first condition with respect to the moving body around the parked vehicle may be a condition regarding the movement of the moving body. In this case, the moving body may include a person and an object. In addition, the first condition may include a plurality of subconditions and may be met when all of the plurality of subconditions are met.

In addition, when the first condition is met, the external notification device of the vehicle may determine 1230 whether at least one of a plurality of second conditions for executing an external notification is met. In this case, the second condition may be a condition regarding a situation in which a vehicle is parked on one side of the parked vehicle. In addition, the second condition may be a condition regarding a situation in which a vehicle is parked on one side of the parked vehicle and may be a condition regarding a situation in which a vehicle next to the parked vehicle exits. According to an embodiment of the present disclosure, the second condition may be a condition regarding recognition of an object or a movement near either side of the parked vehicle.

Meanwhile, when one of the second conditions is met, the external notification device of the parked vehicle may execute 1250 an external notification. In this case, the external notification may be provided via the taillight and door locking sound of the vehicle, but the example is not limited thereto, and the parked vehicle may provide a notification to the outside in various manners.

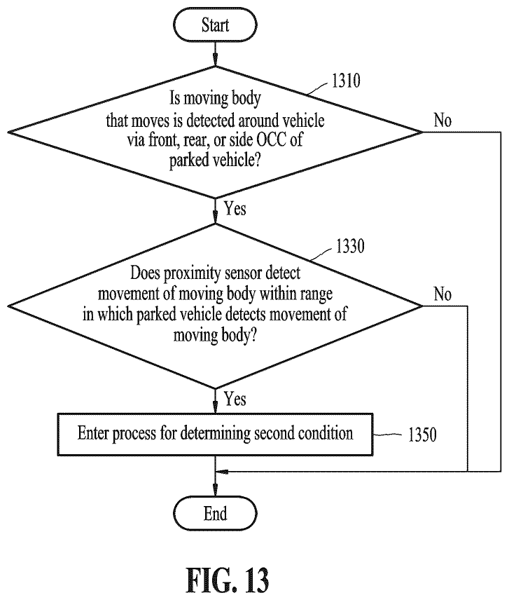

FIG. 13 is a flowchart of a first condition that needs to be met for an external notification device of a parked vehicle to provide a notification to the outside in a notification providing system according to an embodiment.

In this case, the first condition may be a condition regarding a movement of a moving body around a parked vehicle. In addition, the first condition may include two subconditions and may be met when both subconditions are met.

According to a process in an embodiment of the present disclosure shown in FIG. 13, the parked vehicle may detect 1310 a moving body that moves around the vehicle via an OCC-based device installed at the front, rear, or side of the vehicle. In this case, when the movement of the moving body is not detected around the parked vehicle, the process may be terminated.

Meanwhile, when the movement of the moving body is detected around the parked vehicle, the parked vehicle may activate a proximity sensor, such as an ultrasonic sensor or radar. In this case, the activated proximity sensor may detect 1330 the movement of the moving body within a range in which the parked vehicle detects the movement of the moving body. In addition, the range for detecting the movement of the moving body may reflect the door opening length of the vehicle. According to an embodiment, the range for detecting the movement of the moving body may be determined to be 0.6 m. In this case, the process may be terminated when the movement of the moving body within a reference range of the parked vehicle is not detected.

Meanwhile, when the movement within the reference range of the parked vehicle is detected, an external notification device of the parked vehicle may enter 1350 a process for determining a second condition. A detailed description of a process for determining whether the second condition is met is provided below.

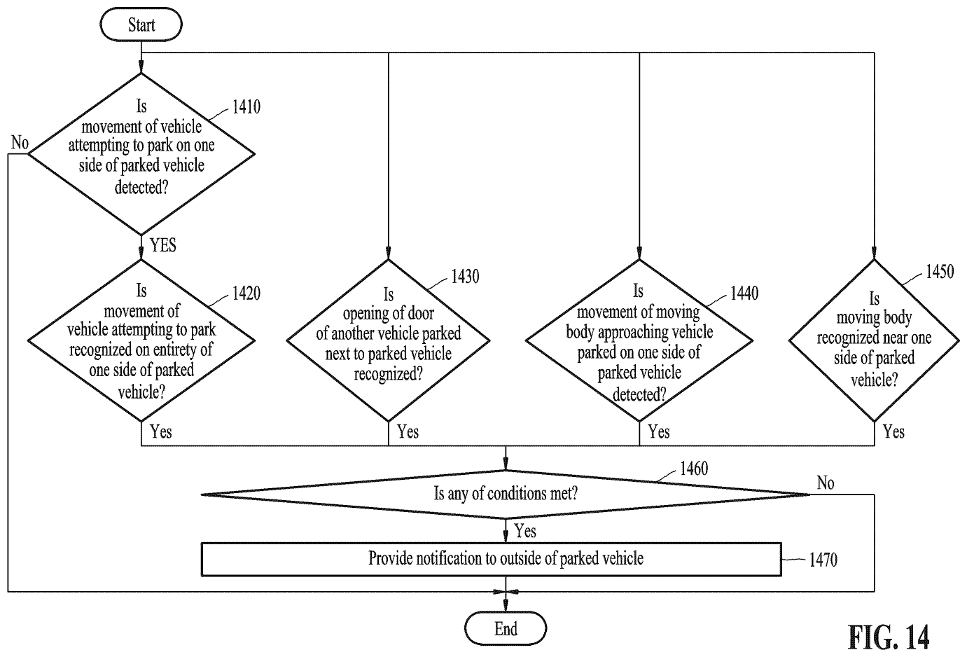

FIG. 14 is a flowchart of a second condition that needs to be met for an external notification device of a parked vehicle to provide a notification to the outside according to an embodiment.

In this case, the second condition may be a subsequent condition of the first condition, and a plurality of second conditions may be provided. When at least one of the plurality of second conditions is met, it may be determined that the second condition is met. In addition, the second condition may correspond to an execution condition for a parked vehicle to provide a notification to the outside.

According to a process in an embodiment of the present disclosure shown in FIG. 14, the external notification device of the parked vehicle may determine whether to execute a notification when another vehicle is parked on one side of the parked vehicle or is already parked as one of the plurality of second conditions. Meanwhile, which of the second conditions is determined first from the plurality of second conditions may vary and is not limited to a specific order. Meanwhile, the order in which one of the plurality of second conditions is determined first may vary and is not limited to a specific order.

According to an embodiment, the external notification device of the parked vehicle may detect 1410 a movement of a vehicle attempting to park on the left or right side of the parked vehicle. In this case, when the movement of the vehicle attempting to park on one side of the parked vehicle is detected, the external notification device of the parked vehicle may determine whether the front or rear of the vehicle attempting to park passes a midpoint of the parked vehicle. According to an embodiment, the midpoint of the parked vehicle may be a B pillar portion of the parked vehicle, but is not limited thereto. Meanwhile, when the front or rear of the vehicle attempting to park passes the midpoint of the parked vehicle, the external notification device of the parked vehicle may determine 1420 whether the movement of the vehicle attempting to park is recognized on an entirety of one side of the parked vehicle. When the movement of the vehicle attempting to park is recognized on the entirety of one side of the parked vehicle, the external notification device may determine that the second condition is met.

According to an embodiment of the present disclosure, when a vehicle is parked on one side of the parked vehicle, the external notification device of the parked vehicle may detect 1430 that a door is open in the vehicle parked next to the parked vehicle. For example, when the external notification device of the parked vehicle recognizes that the door of the vehicle that is parked next to the parked vehicle is open, the external notification device of the parked vehicle may determine that the second condition is met. In this case, the parked vehicle may recognize an opening of the door of the vehicle using an OCC-based device or a proximity sensor, but the method of recognizing the opening of the door of the vehicle is not limited thereto.

According to an embodiment of the present disclosure, the external notification device of the parked vehicle may determine 1440 whether a movement of a person or object approaching the vehicle that is parked on one side of the parked vehicle is detected. When the movement of the person or object approaching the vehicle that is parked on one side of the parked vehicle is detected, the external notification device of the parked vehicle may determine that the vehicle is to exit and may determine that the second condition is met.

According to an embodiment of the present disclosure, the external notification device of the parked vehicle may determine 1450 whether an object or movement is recognized near either side of the parked vehicle. When the object or movement is recognized near either side of the parked vehicle, the external notification device of the parked vehicle may determine that the second condition is met.

The external notification device of the parked vehicle may determine 1460 whether any one of the plurality of second conditions 1410 to 1450 is met to determine whether to provide a notification to the outside of the parked vehicle. When any one of the plurality of second conditions is met, the external notification device of the parked vehicle may provide 1470 a notification to the outside of the parked vehicle. According to an embodiment, the external notification device of the parked vehicle may provide a notification to the outside of the parked vehicle using the vehicle exterior lighting and door locking sound of the vehicle.

Meanwhile, the second conditions may be conditions to determine to prevent the parked vehicle from being hit by a moving body, such as a motorcycle, bicycle, cart, or a person. Meanwhile, when the second condition is not met and other second conditions are not met, the process for the external notification of the parked vehicle may be terminated.

FIG. 15 is a block diagram of an external notification device of a parked vehicle in a notification providing system according to an embodiment.

Referring to FIG. 15, an external notification device 1500 of a parked vehicle may include a communication unit 1510, a processor 1520, and a database (DB) 1530.

The communication unit 1510 may include at least one component for wired or wireless communication with an external server or an external device. For example, the communication unit 1510 may include at least one of a short-range communication unit (not shown), a mobile communication unit (not shown), and a broadcast receiver (not shown).

The DB 1530 may be hardware for storing a variety of data processed by the external notification device 1500 and may store a program to process and control the processor 1520.

The DB 1530 may include random access memory (RAM), such as dynamic RAM (DRAM) and static RAM (SRAM), read-only memory (ROM), electrically erasable programmable ROM (EEPROM), CD-ROM, Blu-ray, or other optical disk storages, a hard disk drive (HDD), solid state drive (SSD), or flash memory.

The processor 1520 may control the overall operation of the external notification device 1500 of the parked vehicle. For example, the processor 1520 may control an input unit (not shown), a display (not shown), the communication unit 1510, and the DB 1530 by executing programs stored in the DB 1530. The processor 1520 may control the operation of the device 1500 of the parked vehicle to provide a notification to the outside by executing the programs stored in the DB 1530.

The processor 1520 may control at least some operations of the device 1500 of the parked vehicle to provide a notification to the outside described above with reference to FIGS. 11A to 14.

For example, the processor 1520 may determine whether a first condition with respect to a moving object around a target vehicle that is parked is met using a sensor of the target vehicle, and when the first condition is met, the processor 1520 may determine whether at least one of a plurality of second conditions for executing an external notification is met, and when one of the second conditions is met, the processor 1520 may execute the external notification.

The processor 1520 may be implemented using at least one of application specific integrated circuits (ASICs), digital signal processors (DSP) s, digital signal processing devices (DSPDs), programmable logic devices (PLDs), field programmable gate arrays (FPGAs), controllers, micro-controllers, microprocessors, and electrical units for performing other functions.

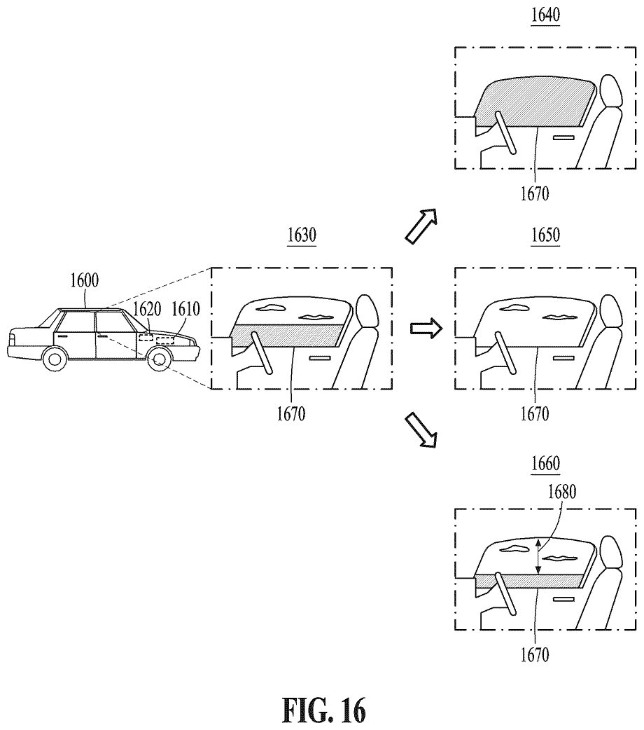

FIG. 16 is a diagram of a case in which ventilation of a vehicle is automatically controlled according to an embodiment.

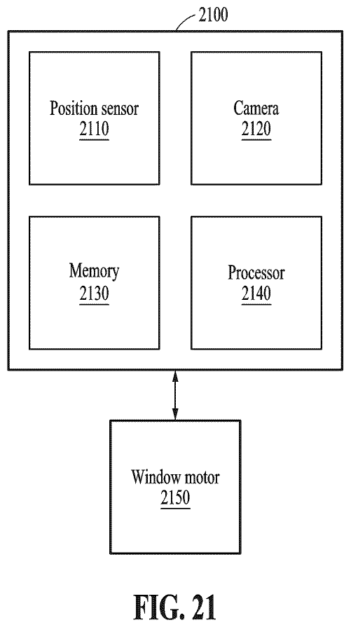

Referring to FIG. 16, a control device (e.g., a control device 2100 of FIG. 21) for controlling ventilation of a vehicle 1600 described herein may automatically control a window 1670 of the vehicle 1600 and/or an air circulation mode of the vehicle 1600. For example, the control device may automatically adjust whether to open or close the window 1670, a degree of opening or closing of the window 1670, and/or the air circulation mode of the vehicle 1600, based on a surrounding situation and/or a position of the vehicle 1600.

A camera 1610 mounted on the vehicle 1600 may obtain a surrounding image of the surrounding of the vehicle 1600, and a position sensor 1620 may measure a position of the vehicle 1600. For example, the camera 1610 may be mounted on the front, rear, left side, or right side of the vehicle to capture a surrounding situation of the vehicle. The camera 1610 may be an example for obtaining the surrounding image and may be replaced with a radar sensor or a light detection and ranging (LiDAR) sensor to obtain the surrounding image. The position sensor 1620 may include a GPS sensor of the vehicle, but the type of the sensor for measuring the position of the vehicle is not limited. The obtained surrounding image and the measured position of the vehicle 1600 may be used for the control device to determine whether to open or close the window 1670 of the vehicle 1600 or a degree 1680 of opening or closing of the window 1670.

Whether to open or close the window 1670 of the vehicle 1600 may be determined by generating an open control signal that is generated by the control device to automatically open the window 1670 or a close control signal for automatically closing the window 1670. Whether to open or close the window 1670 may be determined based on at least one of an occurrence of a predefined event and section-wise window opening or closing manipulation data of the user.

The degree 1680 of opening or closing of the window of the vehicle 1600 may be determined by generating an adjustment control signal that is generated by the control device to adjust the degree 1680 of opening or closing of the window. The degree 1680 of opening or closing of the window may be determined based on at least one of section-wise window opening or closing manipulation data of the user, external environmental information, and the driving speed of the vehicle 1600. The degree 1680 of opening or closing of the window may be adjusted between 0% and 100% of the total window opening degree. The total window opening degree may refer to the degree 1680 of opening or closing of the window when the window 1670 is fully open.

In a previous state 1630 in which the user controls the window 1670 before or during driving or whether to open or close the window 1670 or the degree 1680 of opening or closing of the window 1670 is determined by the control device, the control device may change a state of the window to at least one of states, which are a fully closed state 1640 in which the window 1670 is fully closed by generating a close control signal to fully close the window 1670, a fully open state 1650 in which the window 1670 is fully open by generating an open control signal to fully open the window 1670, or an adjusted state 1660 in which the degree 1680 of opening or closing of the window is adjusted by generating an adjustment control signal to adjust the degree 1680 of opening or closing of the window.

Then, the control device may stop generating the open control signal as an event for generating the open control signal to open the window 1670 has expired. Similarly, as an event for generating the close control signal for closing the window 1670 has expired, the control device may stop generating the close control signal, and as an event for generating the adjustment control signal for adjusting the degree 1680 of opening or closing of the window has expired, the control device may stop generating the adjustment control signal.

In determining whether to open or close the window 1670 of the vehicle 1600, when both an event for generating the open control signal for automatically opening the window 1670 and an event for generating the close control signal for automatically closing the window 1670 occur in a time section, the control device may determine to generate the close control signal. In other words, generation of the close control signal may be prioritized over generation of the open control signal.

In determining the degree 1680 of opening or closing of the window of the vehicle 1600, when both an event for generating the adjustment control signal for adjusting the degree 1680 of opening or closing of the window according to the driving speed of the vehicle 1600 and an event for generating the adjustment control signal for adjusting the degree 1680 of opening or closing of the window according to the environmental information occur in a time section, the control device may determine to generate the adjustment control signal for adjusting the degree 1680 of opening or closing of the window according to the driving speed of the vehicle 1600. In other words, generation of the adjustment control signal for adjusting the degree 1680 of opening or closing of the window according to the driving speed of the vehicle 1600 may be prioritized over generation of the adjustment control signal for adjusting the degree 1680 of opening or closing of the window according to the environmental information. Alternatively, there may be user settings to generate the adjustment control signal for adjusting the degree 1680 of opening or closing of the window according to the driving speed of the vehicle 1600 or the adjustment control signal for adjusting the degree 1680 of opening or closing of window according to the environmental information.

The control device may control the air circulation mode of the vehicle 1600 to an internal circulation mode or an external circulation mode of the vehicle 1600 according to whether the window 1670 of the vehicle 1600 is open or closed. The air circulation mode may include the internal circulation mode for blocking air from the outside of the vehicle and recirculating air inside the vehicle and the external circulation mode for drawing air from the outside of the vehicle and ventilating air inside the vehicle.

In controlling the air circulation mode of the vehicle 1600, when both an event for controlling the air circulation mode of the vehicle 1600 to the internal circulation mode and an event for controlling the air circulation mode of the vehicle 1600 to the external circulation mode in a time section, the control device may determine to control the air circulation mode to the internal circulation mode. In other words, controlling to the internal circulation mode may be prioritized over controlling to the external circulation mode.

One or more control signals generated by the control device may operate a window motor. The window motor may be a motor used for a window system of the vehicle 1600 and may change an open or closed state of the window 1670 or the degree of opening or closing of the window 1670 by vertically moving the window according to one or more control signals. The window motor may include a gear motor, a direct current (DC) motor, a stepper motor, a brushed motor, but is not limited thereto.

In the embodiments described herein, in a set situation, by generating the close control signal for automatically closing the window 1670 of the vehicle 1600, the open control signal for automatically opening the window of the vehicle, and the adjustment control signal for adjusting the degree of opening or closing the window of the vehicle, without manipulation of the user to directly control ventilation of the vehicle, whether to open or close the window of the vehicle or the degree of opening or closing of the window may be determined according to the position of the vehicle, the external environment, and the driving speed, and accordingly, the state of the window of the vehicle may be changed.

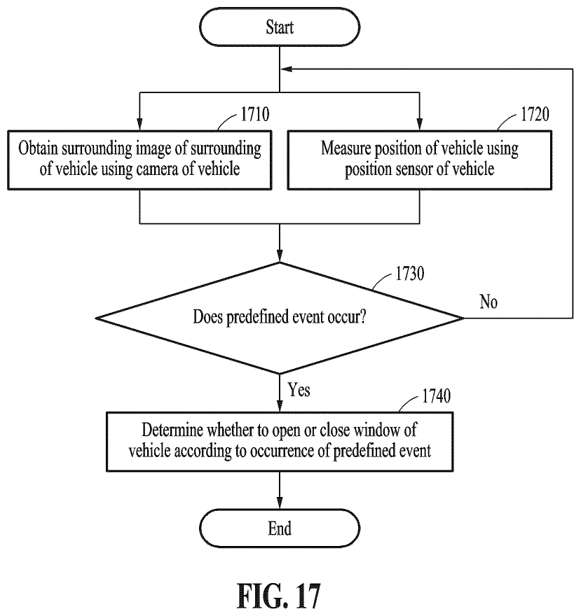

FIG. 17 is a diagram of operations of a method of controlling ventilation of a vehicle based on an occurrence of an event according to an embodiment.

In operation 1710, a control device (e.g., the control device 2100 of FIG. 21) may obtain a surrounding image of the surrounding of a vehicle using a camera of the vehicle. The obtained surrounding image may include a surrounding situation to determine at least one of whether the vehicle is in a traffic congested section and whether a vehicle of a predefined type is present around the vehicle.

In operation 1720, the control device may measure a position of the vehicle using a position sensor of the vehicle.

In operation 1730, the control device may determine whether a predefined event has occurred based on at least one of the obtained surrounding image and the measured position of the vehicle. When the control device determines that the predefined event has occurred, the control device may perform operation 1740, and when the control device determines that the predefined event does not occur, the control device may perform operation 1710 or 1720 again. In operation 1740, the control device may determine whether to open or close a window of the vehicle, according to the occurrence of the predefined event. The occurrence of the predefined event may include at least one of determining that the vehicle is in the traffic congested section based on the measured position of the vehicle, determining that the vehicle of the predefined type is present around the vehicle based on the surrounding image, and determining that the vehicle approaches a predefined position of interest (POI) over time based on at least one of the measured position of the vehicle and the surrounding image.

The control device may use traffic condition information at a current position of the vehicle based on surrounding position information provided by an OCC and a GPS sensor to determine that the vehicle is in the congested section.

In an embodiment, when the control device determines that the vehicle is in the congested section, the control device may generate a close control signal for closing the window of the vehicle. As the close control signal for closing the window of the vehicle is generated, the air circulation mode of the vehicle may be controlled to the internal circulation mode. Then, when the control device determines that the vehicle is not in the traffic jam section, in other words, when the vehicle escapes the congested section, the control device may stop generating the close control signal for closing the window of the vehicle.

The control device may use the traffic condition information at the current position of the vehicle based on the surrounding position information provided by the OCC and the GPS sensor to determine that the vehicle of the predefined type is present within a predefined radius.

The vehicle of the predefined type may include at least one of, for example, a cargo truck, a bus, a truck, or a construction vehicle.

In an embodiment, when the control device determines that the vehicle of the predefined type is present within the predefined radius based on the vehicle, the control device may generate the close control signal for closing the window. As the close control signal for closing the window of the vehicle is generated, the air circulation mode of the vehicle may be controlled to the recirculation mode. Then, when the vehicle of the predefined type is not present within the predefined radius based on the vehicle, in other words, the vehicle of the predefined type moves away from the vehicle, the control device may stop generating the close control signal for closing the window of the vehicle.

The predefined radius may refer to a determined distance between the vehicle of the user and the vehicle of the predefined type, based on the vehicle of the user. The determined distance may be set to a different value depending on a vehicle of a predefined type and may be set by the user.

To determine that the vehicle approaches the predefined POI over time, the control device may use information about a region of interest (ROI) adjacent to the current position of the vehicle based on the surrounding position information provided by the OCC and the GPS sensor.

When the control device determines that the predefined POI based on the vehicle of the user is located in the determined distance from the vehicle of the user, the control device may generate at least one of the close control signal for closing the window or the open control signal for opening the window. The determined distance may be set to a different value depending on the predefined POI and may be set by the user.

The predefined POI may include, for example, at least one of a mountain, a tunnel, a factory, and a waste treatment facility.

In an embodiment, when the control device determines that the vehicle approaches a mountain, the control device may generate the open control signal for opening the window. As the open control signal for opening the window of the vehicle is generated, the air circulation mode of the vehicle may be controlled to the external circulation mode. Next, when the vehicle moves away from the mountain, the control device may stop generating the open control signal for opening the window of the vehicle.

In an embodiment, when the control device determines that the vehicle approaches at least one of a tunnel, a factory, and a waste treatment facility, the control device may generate the close control signal for closing the window. As the close control signal for closing the window of the vehicle is generated, the air circulation mode of the vehicle may be controlled to the internal circulation mode. Next, when the vehicle exits the tunnel or moves away from at least one of the facility or the waste treatment facility, the control device may stop generating the close control signal for closing the window of the vehicle.

In operation 1740, in determining whether to open or close the window of the vehicle, when both the event for generating the open control signal for automatically opening the window and the event for generating the close control signal for automatically closing the window occur, the control device may determine to generate the close control signal. For example, when it is determined that the vehicle approaches a mountain and the vehicle is in the congested section, the control device may determine to generate the close control signal for automatically closing the window.

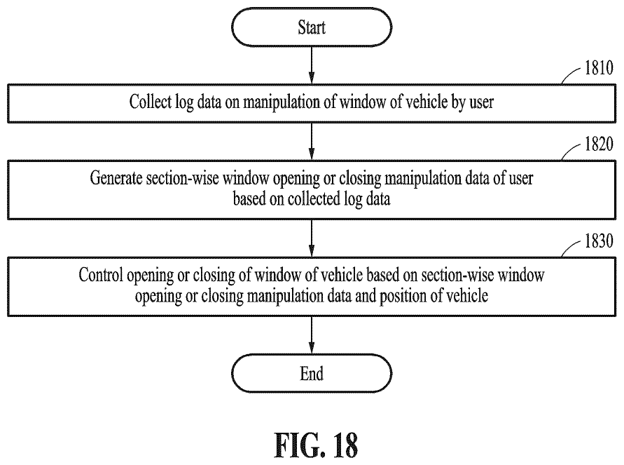

FIG. 18 is a diagram illustrating an operation to control a window of a vehicle to be open or close according to log data of a user according to an embodiment.

In operation 1810, a control device (e.g., the control device 2100 of FIG. 21) may collect log data on manipulation of a window of a vehicle by a user. The log data may include at least one of a history of the user manipulating to close the window of the vehicle in a plurality of driving sections as the user drives the vehicle, a history of manipulating to open the window of the vehicle, a history of adjusting the degree of opening or closing of the window of the vehicle, and a history of controlling an air circulation mode to an internal circulation mode or an external circulation mode.

In operation 1820, the control device may generate section-wise window opening or closing manipulation data of the user based on the collected log data. The control device may generate section-wise window operation data based on a history of the user repeatedly performing operations to close the vehicle's window and operations to open the vehicle's window in a plurality of driving sections of the vehicle collected in log data.

The control device may generate the section-wise window opening or closing manipulation data by analyzing the window manipulation history of the user repeatedly shown in the log data. To generate the section-wise window opening or closing manipulation data, the control device may generate an opening or closing most frequent value for the driving section by calculating the history with more manipulations between the history of the user manipulating the window to close the window of the vehicle and the history of manipulating the window to open the window of the vehicle in the plurality of driving sections in which the user repeatedly manipulates the window of the vehicle. To generate the section-wise window opening or closing manipulation data, the control device may generate a mean of the degree of opening or closing of the window for the driving section by calculating the degree of opening or closing of the window of the vehicle adjusted by the user in the plurality of driving sections in which the user repeatedly manipulates the window of the vehicle. To generate the section-wise window opening or closing manipulation data, the control device may generate an air circulation control most frequent value for the driving section by calculating the history with more manipulations from the history of the user manipulating the air circulation mode of the vehicle to the internal circulation mode and the external circulation mode in the plurality of driving sections in which the user repeatedly controls the air circulation mode of the vehicle.

In operation 1830, the control device may control opening or closing of the window of the vehicle based on the section-wise window opening or closing manipulation data and the position of the vehicle. The control device may determine at least one of whether to open or close the window and the degree of opening or closing of the window based on the section-wise window opening or closing manipulation data. The control device may determine at least one of whether to open or close the window of the vehicle and the degree of opening or closing of the window using the position of the vehicle and information about the predefined POI within a radius of the vehicle.

In an embodiment, when the position of the vehicle corresponds to the plurality of driving sections stored in the section-wise window opening or closing manipulation data, the control device may determine whether to open or close the window of the vehicle according to the generated opening or closing most frequent value. For example, when there are more histories in which the user manipulates the window to close the window between the history in which the user manipulates the window to close the window and the history in which the user manipulates the window to open the window in a driving section, the control device may generate the opening or closing most frequent value for the corresponding driving section to close the window and according to the generated opening or closing most frequent value, the control device may determine to close the window when the vehicle is positioned in the corresponding driving section.

In an embodiment, when the position of the vehicle corresponds to the plurality of driving sections stored in the section-wise window opening or closing manipulation data, the control device may determine the degree of opening or closing of the window of the vehicle according to the generated mean of the degree of opening or closing. For example, when the user adjusts the degree of opening or closing of the window to 10%, 20%, 30%, and 40% of the total window opening degree at different times in a driving section, the control device may generate the mean of the degree of opening or closing for the corresponding driving section to be 25% of the total window opening degree, and may determine the degree of opening or closing of the window to be 25% of the total window opening degree when the vehicle is positioned in the corresponding driving section according to the generated mean of the degree of opening or closing. When the window of the vehicle is already closed, the control device may stop generating the adjustment control signal for adjusting the degree of opening or closing of the window according to the determined degree of opening or closing of the window.

In an embodiment, when the position of the vehicle corresponds to the plurality of driving sections stored in the section-wise window opening or closing manipulation data, the control device may control the air circulation mode of the vehicle to the internal circulation mode or the external circulation mode according to the generated air circulation control most frequent value.

In the plurality of driving sections stored in the section-wise window opening or closing manipulation data, start points and end points of the driving sections may be points at the time when the user changes at least one of whether to open or close the window of the vehicle, the degree of opening or closing of the window of the vehicle, and the air circulation mode.

When the driving sections in which the user repeatedly manipulates the window of the vehicle overlap each other, the control device may calculate an average point of points at the time when the user changes at least one of whether to open or close the window of the vehicle, the degree of opening or closing of the window of the vehicle, and the air circulation mode to define the start point and the end point of the driving section to control opening or closing of the window of the vehicle. When the position of the vehicle corresponds to the average point of start points of the driving sections and corresponds to the average point of end points of the driving sections, the control device may perform at least one of determining whether to open or close the window of the vehicle according to the generated opening or closing most frequent value, determining the degree of opening or closing of the window of the vehicle according to the generated mean of the degree of opening or closing, and controlling the air circulation mode of the vehicle according to the generated air circulation mode most frequent value.

In an embodiment, when the vehicle is driven in driving sections that are determined to be similar to the plurality of driving sections stored in the section-wise window opening or closing manipulation data, the control device may perform at least one of determining whether to open or close the window of the vehicle according to the generated opening or closing most frequent value, determining the degree of opening or closing of the window of the vehicle according to the generated mean of the degree of opening or closing, and controlling the air circulation mode of the vehicle according to the generated air circulation mode control most frequent value. For example, when there are more histories in which the user manipulates the window to open the window than the history in which the user manipulates the window to close the window in a driving section corresponding to a downhill road, the control device may generate the opening or closing most frequent value for the driving section to open the window and may determine to open the window when the vehicle is positioned in another driving section corresponding to a downhill road that is similar to the driving section according to the generated opening or closing most frequent value.

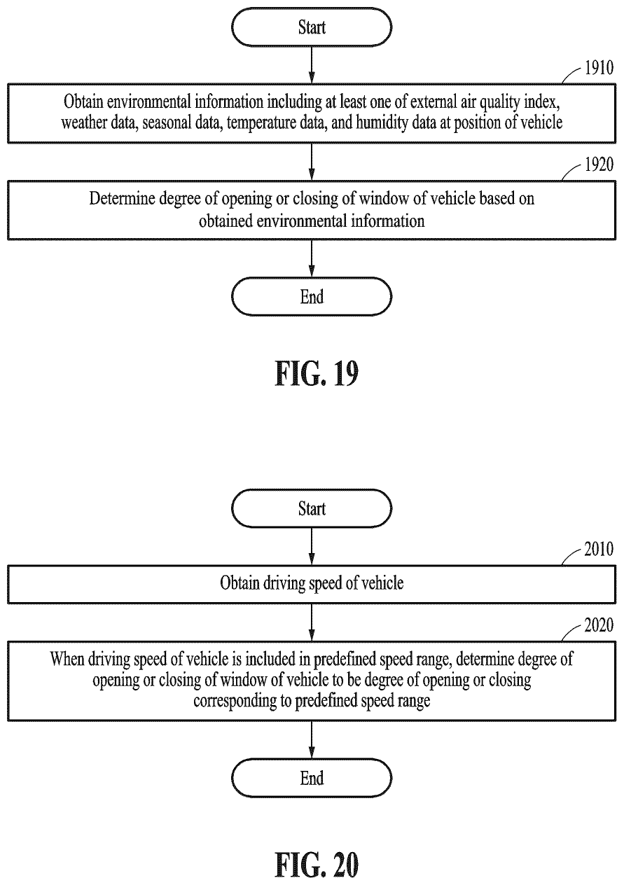

FIG. 19 is a diagram illustrating an operation to determine a degree of opening or closing a window of a vehicle according to environmental information according to an embodiment.

In operation 1910, a control device (e.g., the control device 2100 of FIG. 21) may obtain environmental information including at least one of an external air quality index, weather data, seasonal data, temperature data, and humidity data at a position of the vehicle.

The environmental information may be measured from the outside and may be obtained using an application programming interface (API) provided to the vehicle. The control device may obtain the environmental information including at least one of the external air quality index, the weather data, the seasonal data, the temperature data, and the humidity data at the current position of the vehicle via the API. The external air quality index may be obtained via an air quality index (AQI) in the API. For example, the external air quality may indicate “good” when the AQI is between 0 and 50, “fair” when the AQI is between 51 and 100, “poor” when the AQI is between 101 and 150, and “very poor” when the AQI is 151 or above. The weather data may be obtained using at least one of a camera and a rain detection sensor of the vehicle other than the API. The temperature data and the humidity data may be obtained using an external temperature sensor of the vehicle other than the API.

In operation 1920, the control device may determine the degree of opening or closing of the window of the vehicle based on the obtained environmental information. The control device may generate an adjustment control signal for automatically adjusting the degree of opening or closing of the window based on the degree of opening or closing of the window determined according to the obtained environmental information. For example, when the external air quality is “good” or “fair” or the weather is “clear”, the adjustment control signal for automatically adjusting the degree of opening or closing of the window may be generated based on a predefined degree of opening or closing. The predefined degree of opening or closing may be a degree of opening or closing set by the user in advance.

While generating the adjustment control signal for automatically adjusting the degree of opening or closing of the window according to the obtained environmental information, at least one of a case in which the external AQI is greater than or equal to a threshold value, a case in which it is determined that rain and/or snow falls based on the weather data, and a case in which the window of the vehicle is closed by the manipulation of the user of the vehicle, the control device may stop generating an open control signal for automatically opening the window. For example, when the external air quality is “poor” because the AQI is greater than or equal to 101, which is the threshold value, the control device may stop generating the adjustment control signal that may be generated based on the predefined degree of opening or closing as the weather is “clear”.

In operation 1920, the control device may set a maximum degree of opening or closing of the window based on the current season according to the seasonal data. When the current season is winter, the set maximum degree of opening or closing of the window may be smaller than the maximum degree of opening or closing of the window that is set when the current season is spring, summer, or autumn. For example, a maximum degree of opening or closing of the window that is set in winter may be 30% of the total window opening or closing degree, whereas maximum degrees of opening or closing of the window set in spring, summer, and autumn, respectively may be 15% of the total window opening or closing degree, and the maximum degree of opening or closing of the window based on the seasonal data may be set by the user.

In an embodiment, when the window of the vehicle is open as much as the set maximum degree of opening or closing of the window and the window of the vehicle is further open by the manipulation of the user, the control device may stop generating the adjustment control signal for automatically adjusting the window to the set maximum degree of opening or closing. FIG. 20 is a diagram illustrating an operation to determine a degree of opening or closing a window of a vehicle according to the driving speed of the vehicle according to an embodiment.

In operation 2010, a control device (e.g., the control device 2100 of FIG. 21) may obtain the driving speed of a vehicle. The driving speed of the vehicle may be obtained by at least one of a wheel speed sensor, a digital speedometer, a GPS, and an inertial measurement unit (IMU), but the example is not limited thereto.

In operation 2020, when the driving speed of the vehicle is included in a predefined speed range, the control device may determine a degree of opening or closing of a window to be a degree of opening or closing corresponding to the predefined speed range. The control device may determine the degree of opening or closing of the window to be the degree of opening or closing corresponding to the predefined speed range as the driving speed of the vehicle is maintained to the predefined speed range for a predetermined time period.

The predefined speed range may include a first speed range and a second speed range that is greater than the first speed range, and a first degree of opening or closing corresponding to the first speed range may be greater than a second degree of opening or closing corresponding to the second speed range. For example, when the driving speed of the vehicle corresponds to a speed range that is greater than or equal to 0 km/h and less than 65 km/h, the window may be maintained in an open state, when the driving speed of the vehicle corresponds to a speed range that is greater than or equal to 65 km/h and less than 85 km/h, the degree of opening or closing of the window may be adjusted to 30% of the total window opening degree, when the driving speed of the vehicle corresponds to a speed range that is greater than or equal to 85 km/h and less than 105 km/h, the degree of opening or closing of the window may be adjusted to 10% of the total window opening degree, when the driving speed of the vehicle corresponds to a speed range that is greater than or equal to 105 km/h and less than 125 km/h, the degree of opening or closing of the window may be adjusted to 5% of the total window opening degree, and when the driving speed of the vehicle is greater than or equal to 125 km/h, the degree of opening or closing of the window may be adjusted to 0% of the total window opening degree, and the air circulation mode of the vehicle may be controlled to the external circulation mode. The degree of opening or closing of the window according to the predefined speed range may be set by the user.

In operation 2020, at least one of when the window of the vehicle is in the open state before driving the vehicle, when the window of the vehicle is open by the manipulation of the user while driving the vehicle, and when a mode for automatically adjusting the degree of opening or closing of the window to the degree of opening or closing corresponding to the predefined speed range, the control device may automatically adjust the degree of opening or closing of the window to the degree of opening or closing corresponding to the predefined speed range. The mode for automatically adjusting the degree of opening or closing may be individually applied to each seat. In other words, at least one of when driving starts while the window of each seat is in the open state before driving the vehicle, when the user manipulates the window of each seat to open the window while driving the vehicle, or when the user sets the mode for automatically adjusting the degree of opening or closing of the window of each seat of the vehicle to the degree of opening or closing corresponding to the predefined speed range while driving the vehicle, the degree of opening or closing of the window of each seat may be adjusted to the degree of opening or closing corresponding to the predefined speed range.

In operation 2020, when the degree of opening or closing of the window before the driving speed of the vehicle falls in the second speed range corresponds to the second degree of opening or closing, the control device may maintain the degree of opening or closing of the window to the second degree of opening or closing and may determine the degree of opening or closing of the window after the driving speed of the vehicle falls in the second speed range to be the degree of opening or closing corresponding to the predefined speed range. When the vehicle starts driving with the window opened by 10% of the full opening range, the window opening amount may be maintained at 10% of the full opening range until the vehicle speed corresponds to a speed range of 85 km/h or more and less than 105 km/h. If the vehicle speed is 105 km/h or more, the window opening amount may be adjusted to 5% of the full opening range, and then the window opening amount may be determined according to a predefined opening amount corresponding to the vehicle speed range.

FIG. 21 is a schematic block diagram of a control device for controlling ventilation of a vehicle according to an embodiment.

Referring to FIG. 21, a control device 2100 may be a device for performing a control method described herein. The control device 2100 according to an embodiment may include a position sensor 2110, a camera 2120, a memory 2130, and a processor 2140. In an embodiment, some of the components may be omitted from the control device 2100 or other components may be added to the control device 2100.

The position sensor 2110 may measure a position of a vehicle. The position of the vehicle measured by the position sensor 2110 may be transmitted to the processor 2140 via a communication module.

The camera 2120 may obtain a surrounding image of the surrounding of the vehicle. The surrounding image obtained by the camera 2120 may be transmitted to the processor 2140 via the communication module (not shown).

The communication module may include at least one of, for example, a short-range communication module, a wired communication module, and a wireless communication module.

The short-range communication module may include various short-range communication modules for transmitting and receiving a signal using a wireless communication network in a short range, such as a Bluetooth module, an infrared communication module, a radio frequency identification (RFID) communication module, a wireless local access network (WLAN) communication module, a near field communication (NFC) communication module, or a Zigbee communication module.

The wired communication module may include various wired communication modules, such as a controller area network (CAN) communication module, a local area network (LAN) module, a wide area network (WAN) module, and a value added network (VAN) communication module, as well as various cable communication modules, such as a universal serial bus (USB), a high definition multimedia interface (HDMI), a digital visual interface (DVI), recommended standard 232 (RS-232), power line communication, or a plain old telephone service (POTS).

The wireless communication module may include a wireless fidelity (Wi-Fi) module, a wireless broadband (Wibro) module, and wireless communication modules for supporting various wireless communication schemes, such as global system for mobile communication (GSM), code division multiple access (CDMA), wideband CDMA (WCDMA), universal mobile telecommunications system (UMTS), time division multiple access (TDMA), and long-term evolution (LTE).

The memory 2130 may store information about a vehicle of a predefined type, information about a predefined radius, information about a predefined POI, log data on window manipulation of the vehicle by the user, section-wise window opening or closing manipulation data of the user, and information about a predefined speed range.

The memory 2130 may store a variety of data used by a component (e.g., the position sensor 2110, the camera 2120, and the processor 2140) of the control device 2100. The data may include, for example, a program (e.g., an application), input data or output data on an instruction related thereto, and log data of a computing system. The memory 2130 may store instructions executable by one or more processors 2140. The memory 2130 may include volatile memory or non-volatile memory.

The processor 2140 may determine whether a predefined event has occurred based on at least one of the obtained surrounding image and the measured position of the vehicle, and according to the occurrence of the predefined event, may determine whether to open or close the window of the vehicle.

When it is determined that the vehicle is in a congested section, the processor 2140 may generate a close control signal for closing the window of the vehicle. The processor 2140 may control an air circulation mode of the vehicle to an internal circulation mode as the close control signal for closing the window of the vehicle is generated. Then, when it is determined that the vehicle is not in the congested section, in other words, when the vehicle escapes the congested section, the processor 2140 may stop generating the close control signal for closing the window of the vehicle.

When it is determined that a vehicle of a predefined type is present within a predefined radius based on the vehicle, the processor 2140 may generate the close control signal for closing the window. The processor 2140 may control an air circulation mode of the vehicle to an internal circulation mode as the close control signal for closing the window of the vehicle is generated. Then, when the vehicle of the predefined type is not present within the predefined radius based on the vehicle, in other words, the vehicle of the predefined type moves away from the vehicle, the processor 2140 may stop generating the close control signal for closing the window of the vehicle.

When it is determined that the predefined POI based on the vehicle of the user is located in the determined distance, the processor 2140 may generate at least one of the close control signal for closing the window or the open control signal for opening the window.

When it is determined that the vehicle approaches a mountain, the processor 2140 may generate the open control signal for opening the window. The processor 2140 may control the air circulation mode of the vehicle to the external circulation mode as the open control signal for opening the window of the vehicle is generated. Next, when the vehicle moves away from the mountain, the processor 2140 may stop generating the open control signal for opening the window of the vehicle.

When it is determined that the vehicle approaches at least one of a tunnel, a factory, and a waste treatment facility, the processor 2140 may generate the close control signal for closing the window. The processor 2140 may control the air circulation mode of the vehicle to the internal circulation mode as the close control signal for closing the window of the vehicle is generated. Next, when the vehicle exits the tunnel or moves away from at least one of the facility or the waste treatment facility, the processor 2140 may stop generating the close control signal for closing the window of the vehicle.

In determining whether to open or close the window of the vehicle, when both the event for generating the open control signal for automatically opening the window and the event for generating the close control signal for automatically closing the window occur, the processor 2140 may determine to generate the close control signal.

The processor 2140 may collect log data on manipulation of the window of the vehicle by the user. The processor 2140 may control opening or closing of the window of the vehicle based on the section-wise window opening or closing manipulation data and the position of the vehicle.

The processor 2140 may generate the section-wise window opening or closing manipulation data based on the history in which the user manipulates the window of the vehicle to close the window and the history in which the user manipulates the window to open the window in the plurality of driving sections in which the log data is collected. The processor 2140 may determine at least one of whether to open or close the window and the degree of opening or closing of the window based on the section-wise window opening or closing manipulation data.

The processor 2140 may generate the section-wise window opening or closing manipulation data by analyzing the window manipulation history of the user repeatedly shown in the log data. To generate the section-wise window opening or closing manipulation data, the processor 2140 may generate an opening or closing most frequent value for the driving section by calculating the history with more manipulations between the history of the user manipulating to close the window of the vehicle and the history of manipulating to open the window of the vehicle in the plurality of driving sections in which the user repeatedly manipulates the window of the vehicle. To generate the section-wise window opening or closing manipulation data, the processor 2140 may generate a mean of the degree of opening or closing of the window for the driving section by calculating the degree of opening or closing of the window of the vehicle adjusted by the user in the plurality of driving sections in which the user repeatedly manipulates the window of the vehicle. To generate the section-wise window opening or closing manipulation data, the processor 2140 may generate an air circulation control most frequent value for the driving section by calculating the history with more manipulations from the history of the user manipulating the air circulation mode of the vehicle to the internal circulation mode and the external circulation mode in the plurality of driving sections in which the user repeatedly controls the air circulation mode of the vehicle.

When the position of the vehicle corresponds to the plurality of driving sections stored in the section-wise window opening or closing manipulation data, the processor 2140 may determine whether to open or close the window of the vehicle according to the generated opening or closing most frequent value. When the position of the vehicle corresponds to the plurality of driving sections stored in the section-wise window opening or closing manipulation data, the processor 2140 may determine the degree of opening or closing of the window of the vehicle according to the generated mean of the degree of opening or closing. When the position of the vehicle corresponds to the plurality of driving sections stored in the section-wise window opening or closing manipulation data, the processor 2140 may control the air circulation mode of the vehicle to the internal circulation mode or the external circulation mode according to the generated air circulation control most frequent value.

When the driving sections in which the user repeatedly manipulates the window of the vehicle overlap each other, the processor 2140 may calculate an average point of points at the time when the user changes at least one of whether to open or close the window of the vehicle, the degree of opening or closing of the window of the vehicle, and the air circulation mode to define the start point and the end point of the driving section to control opening or closing of the window of the vehicle. When the position of the vehicle corresponds to the average point of start points of the driving sections and corresponds to the average point of end points of the driving sections, the processor 2140 may perform at least one of determining whether to open or close the window of the vehicle according to the generated opening or closing most frequent value, determining the degree of opening or closing of the window of the vehicle according to the generated mean of the degree of opening or closing, and controlling the air circulation mode of the vehicle according to the generated air circulation mode most frequent value.

When the vehicle is driven in driving sections that are determined to be similar to the plurality of driving sections stored in the section-wise window opening or closing manipulation data, the processor 2140 may perform at least one of determining whether to open or close the window of the vehicle according to the generated opening or closing most frequent value, determining the degree of opening or closing of the window of the vehicle according to the generated mean of the degree of opening or closing, and controlling the air circulation mode of the vehicle according to the generated air circulation mode control most frequent value.

The processor 2140 may determine the degree of opening or closing of the window of the vehicle based on the obtained environmental information. The processor 2140 may generate an adjustment control signal for automatically adjusting the degree of opening or closing of the window based on the degree of opening or closing of the window determined according to the obtained environmental information.

While generating the adjustment control signal for automatically adjusting the degree of opening or closing of the window according to the obtained environmental information, at least one of a case in which the external AQI is greater than or equal to a threshold value, a case in which it is determined that rain and/or snow falls based on the weather data, and a case in which the window of the vehicle is closed by the manipulation of the user of the vehicle, the processor 2140 may stop generating an open control signal for automatically opening the window.

The processor 2140 may set a maximum degree of opening or closing of the window based on the current season according to the seasonal data. When the window of the vehicle is open as much as the set maximum degree of opening or closing of the window and the window of the vehicle is further open by the manipulation of the user, the processor 2140 may stop generating the adjustment control signal for automatically adjusting the window to the set maximum degree of opening or closing.

When the driving speed of the vehicle is included in a predefined speed range, the processor 2140 may determine a degree of opening or closing of a window to be a degree of opening or closing corresponding to the predefined speed range. The processor 2140 may determine the degree of opening or closing of the window to be the degree of opening or closing corresponding to the predefined speed range as the driving speed of the vehicle is maintained to the predefined speed range for a predetermined time period.

At least one of when the window of the vehicle is in the open state before driving the vehicle, when the window of the vehicle is open by the manipulation of the user while driving the vehicle, and when a mode for automatically adjusting the degree of opening or closing of the window to the degree of opening or closing corresponding to the predefined speed range, the processor 2140 may automatically adjust the degree of opening or closing of the window to the degree of opening or closing corresponding to the predefined speed range.

When the degree of opening or closing of the window before the driving speed of the vehicle falls in the second speed range corresponds to the second degree of opening or closing, the processor 2140 may maintain the degree of opening or closing of the window to the second degree of opening or closing and may determine the degree of opening or closing of the window after the driving speed of the vehicle falls in the second speed range to be the degree of opening or closing corresponding to the predefined speed range.

The processor 2140 may control the air circulation mode of the vehicle to the internal circulation mode or the external circulation mode of the vehicle according to whether the window is open or closed. When both an event for controlling the air circulation mode of the vehicle to the internal circulation mode and an event for controlling the air circulation mode of the vehicle to the external circulation mode occur in a time section, the processor 2140 may determine to control the air circulation mode to the internal circulation mode.

The processor 2140 may control other components (e.g., a hardware or software component) of the control device 2100 and may perform various data processing or computations. According to an embodiment, as at least a portion of data processing or computation, the processor 2140 may store an instruction or data received from another component in the memory 2130, may process the instruction or data stored in the memory 2130, and may store resulting data in the memory 2130. The processor 2140 may include a main processor (e.g., a CPU or an application processor (AP)) or an auxiliary processor (e.g., a graphics processing unit (GPU), a neural processing unit (NPU), an image signal processor (ISP), a sensor hub processor, or a communication processor (CP)) that is operable independently from, or in conjunction with the main processor.

At least one of the open control signal, the close control signal, and the adjustment control signal that are generated according to the determination on whether to open or close the window of the vehicle or the degree of opening or closing of the window by the control device 2100 may be transmitted to a window motor 2150 to operate the window motor 2150, and accordingly, a state of the window may be changed.

The method of providing a notification according to an embodiment may include determining whether a first condition with respect to a moving body around a target vehicle is met using a sensor of the target vehicle that is parked. The method may include determining whether at least one of a plurality of second conditions for executing an external notification is met when the first condition is met. The method may include, when one of the second conditions is met, executing the external notification.

The first condition may be determining whether a movement of the moving body is detected using at least one of a plurality of OCC-based device mounted on the target vehicle and determining whether the movement of the moving body is detected around the target vehicle.

Whether the movement of the moving body is detected around the target vehicle may be determined using a proximity sensor of the target vehicle that is activated when the movement of the moving body is detected.

The moving body may be an object that is not in contact with the target vehicle.

The second condition may be determining whether the movement of the moving body that attempts to park on one side of the target vehicle is detected and determining whether the movement of the moving body is recognized on an entirety of one side of the target vehicle.

The determining of whether the movement of the moving body is recognized on the entirety of one side of the target vehicle may be determining whether the front or rear of the moving body that attempts to park on one side of the target vehicle passes a midpoint of the target vehicle, and when the front or rear of the moving body passes the midpoint of the target vehicle, determining whether the movement of the moving body is recognized on the entirety of one side of the target vehicle.

The second condition may be determining whether an opening of a door of the moving body parked on one side of the target vehicle is recognized.

The second condition may be determining whether the movement of the moving body that approaches a vehicle parked on one side of the target vehicle is detected.

The second condition may be determining whether at least one of the moving body or the movement of the moving body is detected within an adjacent distance of one side of the target vehicle.

When the target vehicle is parked in an exclusion location, it may not be determined whether the first condition is met.

A notification device according to an embodiment may include memory storing at least one program and a processor for performing an operation by executing the at least one program. The processor may determine whether a first condition with respect to a moving object around a target vehicle that is parked is met using a sensor of the target vehicle, and when the first condition is met, the processor may determine whether at least one of a plurality of second conditions for executing an external notification is met, and when one of the second conditions is met, the processor may execute the external notification.

A method of controlling ventilation of a vehicle according to an embodiment may include obtaining a surrounding image of the surrounding of a vehicle using a camera of the vehicle. The method may include measuring a position of the vehicle using a position sensor of the vehicle. The method may include determining whether a predefined event has occurred based on at least one of the obtained surrounding image and the measured position of the vehicle. The method may include determining whether to open or close a window of the vehicle according to an occurrence of the predefined event.

The occurrence of the predefined event may include determining that the vehicle is in a traffic congested section based on the measured position of the vehicle. The occurrence of the predefined event may include determining that a vehicle of a predefined type is present around the vehicle based on the surrounding image. The occurrence of the predefined event may include determining that the vehicle approaches a predefined position of interest over time according to at least one of the measured position of the vehicle and the surrounding image.

The vehicle of the predefined type may include at least one of a cargo truck, a bus, a truck, or a construction vehicle. The determining of whether to open or close the window of the vehicle may include, when it is determined that the vehicle of the predefined type is present within a predefined radius based on the vehicle, generating a close control signal for closing the window.

The predefined position of interest may include at least one of a mountain, a tunnel, a factory, and a waste treatment facility.

The determining of whether to open or close the window of the vehicle may include, when it is determined that the vehicle approaches the mountain, generating an open control signal for opening the window. The determining of whether to open or close the window of the vehicle may include, when it is determined that the vehicle approaches at least one of the tunnel, the factory, or the waste treatment facility, generating a close control signal for closing the window.

The method may further include collecting log data on manipulation of the window of the vehicle by a user. The method may further include generating section-wise window opening or closing manipulation data of the user based on the collected log data. The method may further include controlling opening or closing of the window of the vehicle based on the section-wise window opening or closing manipulation data and the position of the vehicle.

The generating of the section-wise window opening or closing manipulation data of the user may include the section-wise window opening or closing manipulation data based on a history in which the user manipulates the window of the vehicle to close the window and a history in which the user manipulates the window of the vehicle to open the window in a plurality of driving sections of the vehicle in which the log data is collected.

The controlling of the opening or closing of the window of the vehicle may include determining at least one of whether to open or close the window and a degree of opening or closing of the window based on the section-wise window opening or closing manipulation data.

The determining of whether to open or close the window of the vehicle may include, when both an event for generating the open control signal for automatically opening the window and an event for generating the close control signal for automatically closing the window occur, determining to generate the close control signal.

The method may further include obtaining environmental information including at least one of an external AQI, weather data, seasonal data, temperature data, and humidity data at the position of the vehicle. The method may further include determining the degree of opening or closing of the window of the vehicle based on the obtained environmental information. The determining of the degree of opening or closing of the window of the vehicle may include at least one of (1) when the external AQI is greater than or equal to a threshold value, (2) when it is determine that rain and/or snow falls based on the weather data, and (3) when the window of the vehicle is closed by manipulation of the user of the vehicle, stopping generating the open control signal for automatically opening the window.

The determining of the degree of opening or closing of the window of the vehicle may include setting a maximum degree of opening or closing of the window based on current season according to the seasonal data. A maximum degree of opening or closing of the window that is set when the current season corresponds to winter may be less than maximum degrees of opening or closing of the window that are set when the current season corresponds to spring, summer, and autumn, respectively.

When the driving speed of the vehicle is included in a predefined speed range, the method may further include determining the degree of opening or closing of the window to be a degree of opening or closing of the window corresponding to the predefined speed range. The predefined speed range may include a first speed range and a second speed range that is greater than the first speed range. A first degree of opening or closing corresponding to the first speed range may be greater than a second degree of opening or closing corresponding to the second speed range.

The determining of the degree of opening or closing of the window of the vehicle may include at least one of (1) when the window of the vehicle is in an open state before the vehicle is driven, (2) when the window of the vehicle is open by manipulation of the user while driving the vehicle, and (3) when a mode for automatically adjusting the degree of opening or closing of the window is set to the degree of opening or closing corresponding to the predefined speed range by manipulation of the user, automatically adjusting the degree of opening or closing of the window to the degree of opening or closing corresponding to the predefined speed range.

When a degree of opening or closing of the window before the driving speed of the vehicle falls in the second speed range corresponds to the second degree of opening or closing, the method may further include maintaining the degree of opening or closing of the window to the second degree of opening or closing and determining the degree of the opening or closing of the window of the vehicle to be the degree of opening or closing corresponding to the predefined speed range after the driving speed of the vehicle falls in the second speed range.

The method may further include controlling an air circulation mode of the vehicle to an internal circulation mode or an external circulation mode of the vehicle according to whether the window is open or closed.

The controlling of the air circulation mode of the vehicle may include, when both an event for controlling the air circulation mode of the vehicle to the internal circulation mode and an event for controlling the air circulation mode of the vehicle to the external circulation mode occur in a time section, determining to control the air circulation mode to the internal circulation mode.

A device for controlling ventilation of a vehicle according to an embodiment may include a camera for obtaining a surrounding image of surrounding of the vehicle, a position sensor for measuring a position of the vehicle, a memory, and one or more processors.

The processor may determine whether a predefined event has occurred based on at least one of the obtained surrounding image and the measured position of the vehicle. The processor may determine whether to open or close the window of the vehicle according to the occurrence of the predefined event. The occurrence of the predefined event may include determining that the vehicle is in a traffic congested section based on the measured position of the vehicle. The occurrence of the predefined event may include determining that a vehicle of a predefined type is present around the vehicle based on the surrounding image. The occurrence of the predefined event may include determining that the vehicle approaches a predefined position of interest over time according to at least one of the measured position of the vehicle and the surrounding image.

The vehicle of the predefined type may include at least one of a cargo truck, a bus, a truck, or a construction vehicle. When it is determined that a vehicle of a predefined type is present within a predefined radius based on the vehicle, the processor may generate the close control signal for closing the window.

The predefined position of interest may include at least one of a mountain, a tunnel, a factory, and a waste treatment facility. When it is determined that the vehicle approaches a mountain, the processor may generate the open control signal for opening the window. When it is determined that the vehicle approaches at least one of a tunnel, a factory, and a waste treatment facility, the processor may generate the close control signal for closing the window.

The processor may collect log data on manipulation of the window of the vehicle by the user. The processor may generate section-wise window opening or closing manipulation data of the user based on the collected log data. The processor may control opening or closing of the window of the vehicle based on the section-wise window opening or closing manipulation data and the position of the vehicle.

The processor may generate the section-wise window opening or closing manipulation data based on the history in which the user manipulates the window of the vehicle to close the window and the history in which the user manipulates the window to open the window in the plurality of driving sections in which the log data is collected. The processor may determine at least one of whether to open or close the window and the degree of opening or closing of the window based on the section-wise window opening or closing manipulation data.

When both an event for generating the open control signal for automatically opening the window and an event for generating the close control signal for automatically closing the window occur, the processor may determine to generate the close control signal.

When the driving speed of the vehicle is included in a predefined speed range, the processor may determine the degree of opening or closing of the window to be a degree of opening or closing of the window corresponding to the predefined speed range. The predefined speed range may include a first speed range and a second speed range that is greater than the first speed range. A first degree of opening or closing corresponding to the first speed range may be greater than a second degree of opening or closing corresponding to the second speed range.

When a degree of opening or closing of the window before the driving speed of the vehicle falls in the second speed range corresponds to the second degree of opening or closing, the processor may maintain the degree of opening or closing of the window to the second degree of opening or closing and may determine the degree of the opening or closing of the window of the vehicle to be the degree of opening or closing corresponding to the predefined speed range after the driving speed of the vehicle falls in the second speed range.

The processor may control an air circulation mode of the vehicle to an internal circulation mode or an external circulation mode of the vehicle according to whether the window is open or closed. When both an event for controlling the air circulation mode of the vehicle to the internal circulation mode and an event for controlling the air circulation mode of the vehicle to the external circulation mode occur in a time section, the processor may determine to control the air circulation mode to the internal circulation mode.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as ROM, RAM, flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. A method of controlling a turn signal, the method comprising:
based on route information of a vehicle, identifying a position where a direction change of the vehicle is required; and
based on a distance between the position where the direction change is required and a position of the vehicle, controlling a turn signal of the vehicle corresponding to the direction change.

2. The method of claim 1,
wherein the route information is obtained by a navigation system.

3. The method of claim 1,
wherein the controlling of the turn signal of the vehicle comprises:
calculating a reference distance required for the direction change; and
activating the turn signal when the distance between the position where the direction change is required and the position of the vehicle is less than or equal to the reference distance.

4. The method of claim 3,
wherein the calculating of the reference distance comprises:
differently calculating the reference distance according to a level of a driver of the vehicle.

5. The method of claim 4,
wherein the level of the driver of the vehicle is determined based on an expected time taken for the driver of the vehicle to perform the direction change.

6. The method of claim 3,
wherein the calculating of the reference distance comprises:
calculating the reference distance based on a speed limit of a road on which the vehicle is driven.

7. The method of claim 3, further comprising:
based on the route information, determining whether the direction change of the vehicle is continuously required, and
wherein the calculating of the reference distance comprises:
when the direction change is continuously required, based on a number of continuous direction changes, calculating the reference distance.

8. The method of claim 3,
wherein the calculating of the reference distance comprises:
calculating the reference distance based on a level of congestion of a road on which the vehicle is to perform the direction change.

9. The method of claim 1, further comprising:
when the vehicle does not perform the direction change according to the turn signal, based on changed route information, reidentifying a position where a direction change of the vehicle is required; and
based on a distance between the reidentified position where the direction change is required and the position of the vehicle, controlling a turn signal corresponding to the reidentified direction change.

10. An electronic device for controlling a turn signal, the electronic device comprising:
a processor; and
memory storing instructions,
wherein the instructions, when executed by the processor, cause the electronic device to:
based on route information of a vehicle, identify a position where a direction change of the vehicle is required, and
based on a distance between the position where the direction change is required and a position of the vehicle, control a turn signal of the vehicle corresponding to the direction change.

11. The electronic device of claim 10,
wherein the route information is obtained by a navigation system.

12. The electronic device of claim 10,
wherein the instructions, when executed by the processor, cause the electronic device to:
calculate a reference distance required for the direction change, and
activate the turn signal when the distance between the position where the direction change is required and the position of the vehicle is less than or equal to the reference distance.

13. The electronic device of claim 12,
wherein the instructions, when executed by the processor, cause the electronic device to:
differently calculate the reference distance according to a level of a driver of the vehicle.

14. The electronic device of claim 13,
wherein the level of the driver of the vehicle is determined based on an expected time taken for the driver of the vehicle to perform the direction change.

15. The electronic device of claim 12,
wherein the instructions, when executed by the processor, cause the electronic device to:
calculate the reference distance based on a speed limit of a road on which the vehicle is driven.

16. The electronic device of claim 12,
wherein the instructions, when executed by the processor, cause the electronic device to:
based on the route information, determine whether the direction change of the vehicle is continuously required, and
when the direction change is continuously required, based on a number of continuous direction changes, calculate the reference distance.

17. The electronic device of claim 12,
wherein the instructions, when executed by the processor, cause the electronic device to:
calculate the reference distance based on a level of congestion of a road on which the vehicle is to perform the direction change.

18. The electronic device of claim 10,
wherein the instructions, when executed by the processor, cause the electronic device to:
when the vehicle does not perform the direction change according to the turn signal, based on changed route information, reidentify a position where a direction change of the vehicle is required, and
based on a distance between the reidentified position where the direction change is required and the position of the vehicle, control a turn signal corresponding to the reidentified direction change.
